(19) United States
(12) Patent Application Publication
(10) Pub. No.: US 2019/0235752 A1
(43) Pub. Date: Aug. 1, 2019

(54) APPARATUS AND METHOD TO IMPROVE OPERABILITY OF OBJECTS DISPLAYED ON A DISPLAY SURFACE OF A THING

(71) Applicant: FUJITSU LIMITED, Kawasaki-shi (JP)

(72) Inventor: AYUMI TASHIRO, Oota (JP)

(73) Assignee: FUJITSU LIMITED, Kawasaki-shi (JP)

(21) Appl. No.: 16/257,364

(22) Filed: Jan. 25, 2019

(30) Foreign Application Priority Data
Jan. 26, 2018 (JP) 2018-011800

(51) Int. Cl. G06F 3/0488; G06F 3/0484; G06F 16/28

(52) U.S. Cl. CPC G06F 3/04886; G06F 16/289; G06F 3/04842

(57) ABSTRACT

An apparatus display, on display surfaces of things, plural pieces of information that respectively represent a plurality of areas on the display surfaces. Upon accepting designation of a first area and a second area among the plurality of areas, the apparatus, with reference to a memory that stores an object displayed in an area in association with the area, identifies a first object displayed in the first area and a second object displayed in the second area. The apparatus displays, in a third area on the display surfaces, information that represents the third area, together with the identified first object and the identified second object.

### CROSS-REFERENCE TO RELATED APPLICATION

This application is based upon and claims the benefit of priority of the prior Japanese Patent Application No. 2018-11800, filed on Jan. 26, 2018, the entire contents of which are incorporated herein by reference.

### FIELD

The embodiments discussed herein are related to apparatus and method to improve operability of objects displayed on a display surface of a thing.

### BACKGROUND

In recent years, for example, a user interface technique has come into existence that causes terminals (for example, notebook personal computer (PC) or smartphone) owned by the respective participants of a meeting and a display apparatus (for example, projector) set in a room to cooperate with each other to display information in the terminals as objects on the respective things (for example, desk, wall, and so forth) in the room (hereinafter, this technique will be referred to also as spatial UI technique). In this spatial UI technique, for example, it becomes possible to cause objects displayed on different things to collaborate and display information (characters or the like) described by a participant in handwriting as an object. Thus, it becomes possible for the respective participants to efficiently share information in the terminal and handwritten information, for example, by utilizing the spatial UI technique (for example, refer to Japanese Laid-open Patent Publication No. 2006-019895).

### SUMMARY

According to an aspect of the embodiments, an apparatus displays, on display surfaces of things, plural pieces of information that respectively represent a plurality of areas. Upon accepting designation of a first area and a second area among the plurality of areas, the apparatus, with reference to a memory that stores an object displayed in an area in association with the area, identifies a first object displayed in the first area and a second object displayed in the second area, and displays, in a third area on the display surfaces, information that represents the third area, together with the identified first object and the identified second object.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of an information processing system;

FIG. 2 is a diagram illustrating a hardware configuration of an information processing apparatus;

FIG. 3 is a block diagram of functions of an information processing apparatus 1;

FIG. 4 is a flowchart diagram for explaining an outline of display control processing in a first embodiment;

FIG. 5 is a flowchart diagram for explaining an outline of display control processing in the first embodiment;

FIG. 6 is a flowchart diagram for explaining an outline of display control processing in the first embodiment;

FIG. 7 is a flowchart diagram for explaining an outline of display control processing in the first embodiment;

FIG. 8 is a flowchart diagram for explaining an outline of display control processing in the first embodiment;

FIG. 9 is a flowchart diagram for explaining an outline of display control processing in the first embodiment;

FIG. 10 is a flowchart diagram for explaining details of display control processing in the first embodiment;

FIG. 11 is a flowchart diagram for explaining details of display control processing in the first embodiment;

FIG. 12 is a flowchart diagram for explaining details of display control processing in the first embodiment;

FIG. 13 is a flowchart diagram for explaining details of display control processing in the first embodiment;

FIG. 14 is a flowchart diagram for explaining details of display control processing in the first embodiment;

FIG. 15 is a flowchart diagram for explaining details of display control processing in the first embodiment;

FIG. 16 is a diagram for explaining a concrete example of object information;

FIG. 17 is a diagram for explaining details of display control processing in the first embodiment;

FIG. 18 is a diagram for explaining details of display control processing in the first embodiment;

FIG. 19 is a diagram for explaining a concrete example of area information;

FIG. 20 is a diagram for explaining a concrete example of object information;

FIG. 21 is a diagram for explaining details of display control processing in the first embodiment;

FIG. 22 is a diagram for explaining a concrete example of area information;

FIG. 23 is a diagram for explaining details of display control processing in the first embodiment;

FIG. 24 is a diagram for explaining a concrete example of area information;

FIG. 25 is a diagram for explaining a concrete example of object information;

FIG. 26 is a diagram for explaining details of display control processing in the first embodiment;

FIG. 27 is a diagram for explaining details of display control processing in the first embodiment;

FIG. 28 is a diagram for explaining a concrete example of area information;

FIG. 29 is a diagram for explaining a concrete example of object information;

FIG. 30 is a diagram for explaining details of display control processing in the first embodiment;

FIG. 31 is a diagram for explaining a concrete example of area information;

FIG. 32 is a diagram for explaining a concrete example of object information;

FIG. 33 is a diagram for explaining details of display control processing in the first embodiment;

FIGS. 34A and 34B illustrates diagrams for explaining a concrete example of area information; and

FIGS. 35A and 35B illustrates diagrams for explaining a concrete example of area information.

### DESCRIPTION OF EMBODIMENTS

A participant like the above-described one classifies each object in accordance with a given criterion and carries out display for each of the classified objects in some cases, for example. For example, the participant classifies each object according to the degree of priority and displays each of the classified objects in a respective one of plural areas defined according to each degree of priority on a thing. This allows the participant to carry out display of objects according to the progress status of the meeting and so forth, for example.

However, in this case, the participant manages the meanings of the areas in which the respective objects are displayed and the classification method of each object for oneself. For this reason, for example, if the management of the areas in which the respective objects are displayed and so forth are not properly carried out, it becomes difficult for each participant to easily carry out operation for the respective objects in some cases.

Thus, it is preferable to improve operability of objects displayed on a thing.

[Configuration of Information Processing System]

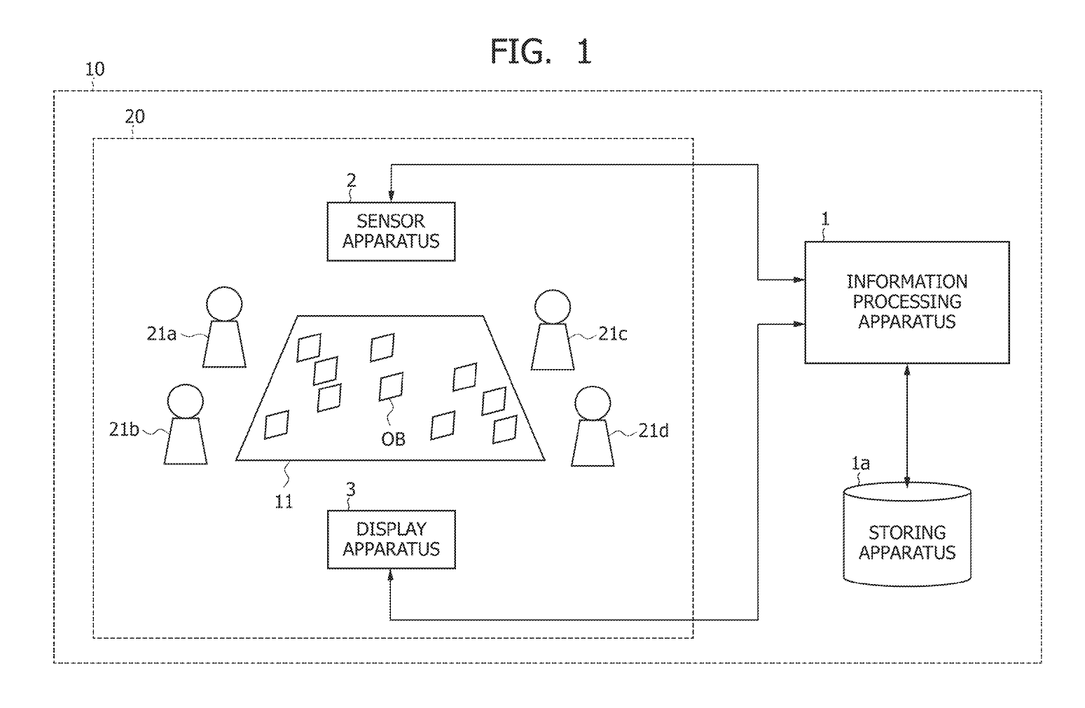

FIG. 1 is a diagram illustrating a configuration of an information processing system. An information processing system 10 illustrated in FIG. 1 includes an information processing apparatus 1 (hereinafter, referred to also as display control apparatus 1), a sensor apparatus 2 such as a camera (infrared camera), and a display apparatus 3 such as a projector. The sensor apparatus 2 and the display apparatus 3 are apparatuses set in a meeting room 20, for example. Furthermore, the information processing apparatus 1 may access the sensor apparatus 2 and the display apparatus 3 through a network that is not illustrated. Hereinafter, suppose that a display surface 11 of a thing (for example, a desk) is set in the meeting room 20 and a meeting by participants 21a, 21b, 21c, and 21d (hereinafter, they will be referred to also as participant 21 collectively) is being held. In FIG. 1, the upper surface of the desk is set as the display surface 11 of the desk.

In the example illustrated in FIG. 1, the sensor apparatus 2 detects action by the participant 21 on the display surface 11 (the upper surface) of the desk. For example, the sensor apparatus 2 detects that the participant 21 has described handwritten characters on the display surface 11 of the desk. Then, in this case, the sensor apparatus 2 transmits an image including the detected handwritten characters to the information processing apparatus 1, for example.

Subsequently, when receiving the image including the handwritten characters from the sensor apparatus 2, the information processing apparatus 1 generates an object OB by digitalizing the handwritten characters included in the received image. Then, the information processing apparatus 1 transmits an instruction to display the generated object OB on the display surface 11 of the desk to the display apparatus 3 and stores information relating to the generated object OB in a storing apparatus 1a.

Thereafter, when receiving the instruction to display the object OB from the information processing apparatus 1, the display apparatus 3 displays the object OB corresponding to the received instruction on the display surface 11 of the desk.

Furthermore, in the example illustrated in FIG. 1, the sensor apparatus 2 detects that the participant 21 has made action for displaying information in a smartphone (not illustrated) of the participant 21 on the display surface 11 of the desk. For example, when detecting action of waving the smartphone by the participant 21 near the display surface 11 of the desk, the sensor apparatus 2 determines that the participant 21 has made action for displaying the information in the smartphone on the display surface 11 of the desk. Then, for example, when detecting that the participant 21 has waved the smartphone near the display surface 11 of the desk, the sensor apparatus 2 transmits an instruction to display the information in the smartphone of the participant 21 to the information processing apparatus 1.

Subsequently, when receiving the instruction to display the information in the smartphone of the participant 21 from the sensor apparatus 2, the information processing apparatus 1 accesses the smartphone of the participant 21. Then, for example, the information processing apparatus 1 acquires information specified by the participant 21 in advance in the information in the smartphone of the participant 21 and generates an object OB including the acquired information. Moreover, the information processing apparatus 1 transmits an instruction to display the generated object OB to the display apparatus 3 and stores information relating to the generated object OB in the storing apparatus 1a.

Thereafter, when receiving the instruction to display the object OB from the information processing apparatus 1, the display apparatus 3 displays the object OB corresponding to the received instruction on the display surface 11 of the desk.

Furthermore, in the example illustrated in FIG. 1, the sensor apparatus 2 detects that the participant 21 has made action for changing the display position of the object OB that has been displayed on the display surface 11 of the desk. For example, when detecting action of moving the object OB from the present display position to a new display position by using a pen-type input apparatus (not illustrated), the sensor apparatus 2 determines that the participant 21 has made action for changing the display position of the object OB. Then, for example, when detecting the action of moving the object OB from the present display position to the new display position, the sensor apparatus 2 transmits an instruction to change the display position of the object OB to the new display position to the information processing apparatus 1.

Subsequently, when receiving the instruction to change the display position of the object OB, the information processing apparatus 1 transmits, to the display apparatus 3, an instruction to turn the object OB at the present display position to the non-displayed state and an instruction to display the object OB at the new display position. Furthermore, the information processing apparatus 1 stores information relating to the change of the display position of the object OB in the storing apparatus 1a.

Thereafter, when receiving the instruction to turn the object OB at the present display position to the non-displayed state and the instruction to display the object OB at the new display position, the display apparatus 3 turns the object OB at the present display position to the non-displayed state and displays the object OB at the new display position.

This allows the information processing apparatus 1 to easily carry out display of a new object OB in line with the progress of the meeting or the like and change of the display position of the object OB that has been displayed, for example.

Here, in some cases, the participant 21 like the above-described one classifies each object OB in accordance with a given criterion and carries out display for each of the classified objects OB, for example, according to the progress of the meeting or the like. For example, the participant 21 classifies the respective objects OB into plural groups according to the degree of priority and displays each of the classified objects OB in a respective one of areas corresponding to the respective degrees of priority on the display surface 11 of the desk. This allows the participant 21 to carry out display of the objects OB according to the progress status of the meeting and so forth, for example.

However, in this case, the participant 21 manages the meanings of the areas in which the respective objects OB are displayed and the number of objects OB displayed in each area for oneself. For this reason, for example, if the management of the number of objects OB displayed in each area and so forth are not properly carried out due to insufficiency in coordination with the participant 21 who participates in the meeting from a remote place (place other than the meeting room 20), or the like, it becomes difficult for each participant 21 to easily carry out operation of the objects OB displayed in the respective areas in some cases.

Thus, the information processing apparatus 1 in the present embodiment displays plural pieces of information that represent each of plural areas on the display surface 11 (for example, labels in which the names of the respective areas are described). Then, the information processing apparatus 1 accepts designation of a first area and a second area, for example, in the plural areas.

Subsequently, the information processing apparatus 1 refers to the storing apparatus 1a that stores the objects OB displayed in the areas in association with the respective areas and identifies the objects OB displayed in the designated first area (hereinafter, referred to also as first objects OBa) and the objects OB displayed in the designated second area (hereinafter, referred to also as second objects OBb).

Thereafter, for example, the information processing apparatus 1 displays information that represents a third area on the display surface 11 and displays the identified first objects OBa and second objects OBb in the third area.

For example, the information processing apparatus 1 defines plural areas on the display surface 11 in advance based on information input by the participant 21. Then, the information processing apparatus 1 stores the information that represents each of the plural areas in the storing apparatus 1a in advance.

Thereafter, for example, if an instruction to merge the first area and the second area in the plural areas to define the third area is made, the information processing apparatus 1 refers to the information stored in the storing apparatus 1a in advance. Then, the information processing apparatus 1 identifies the objects OB displayed in a respective one of the first area and the second area (first objects OBa and second objects OBb) and displays each of the identified objects OB in the third area.

This allows the information processing apparatus 1 to manage each of the pieces of information that represent the respective areas decided by the participant 21. Thus, it becomes possible for the participant 21 to easily carry out operation of the objects OB displayed in the respective areas without managing the pieces of information that represent the respective areas for oneself. For example, it becomes possible for the participant 21 to easily carry out operation such as movement of the display position of the object OB displayed on the display surface 11 of a thing and merging of plural areas defined on the display surface 11.

[Hardware Configuration of Information Processing System]

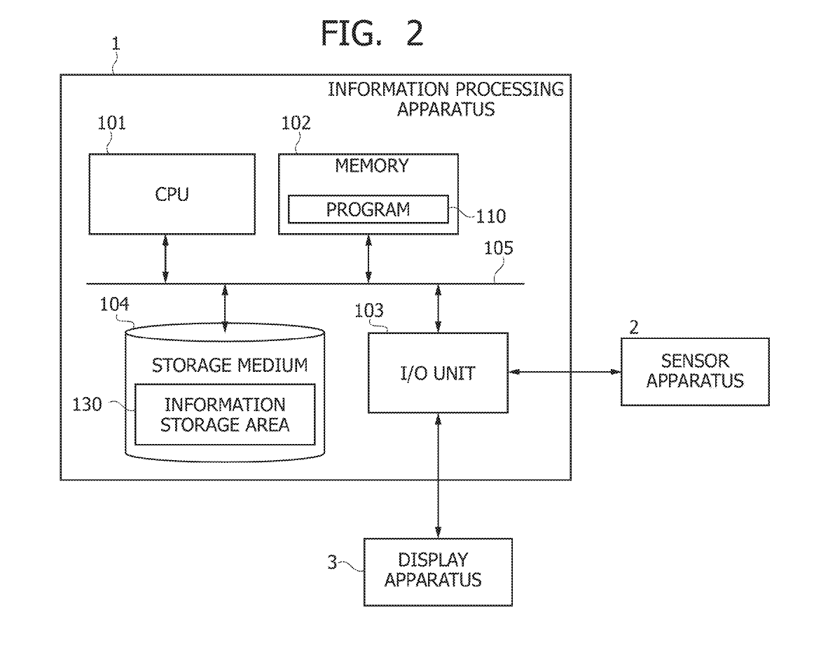

Next, the hardware configuration of the information processing system 10 will be described. FIG. 2 is a diagram illustrating a hardware configuration of an information processing apparatus. The information processing apparatus illustrated in FIG. 2 may be the information processing apparatus 1 illustrated in FIG. 1.

As illustrated in FIG. 2, the information processing apparatus 1 includes a central processing unit (CPU) 101 that is a processor, a memory 102, an external interface 103 (hereinafter, referred to also as I/O unit 103), and a storage medium 104. The respective units are coupled to each other through a bus 105.

The storage medium 104 stores a program 110 for executing processing of controlling display of the object OB on the display surface 11 (hereinafter, referred to also as display control processing) in a program storage area (not illustrated) in the storage medium 104, for example. The storage medium 104 may be a hard disk drive (HDD), for example.

Furthermore, the storage medium 104 includes a storing unit 130 (hereinafter, referred to also as information storage area 130) that stores information used when the display control processing is executed, for example. The information storage area 130 may be the storing apparatus 1a illustrated in FIG. 1, for example.

The CPU 101 executes the program 110 loaded from the storage medium 104 into the memory 102 and executes the display control processing.

The external interface 103 carries out communication with the sensor apparatus 2 and the display apparatus 3 through a network (not illustrated), for example.

[Functions of Information Processing Apparatus]

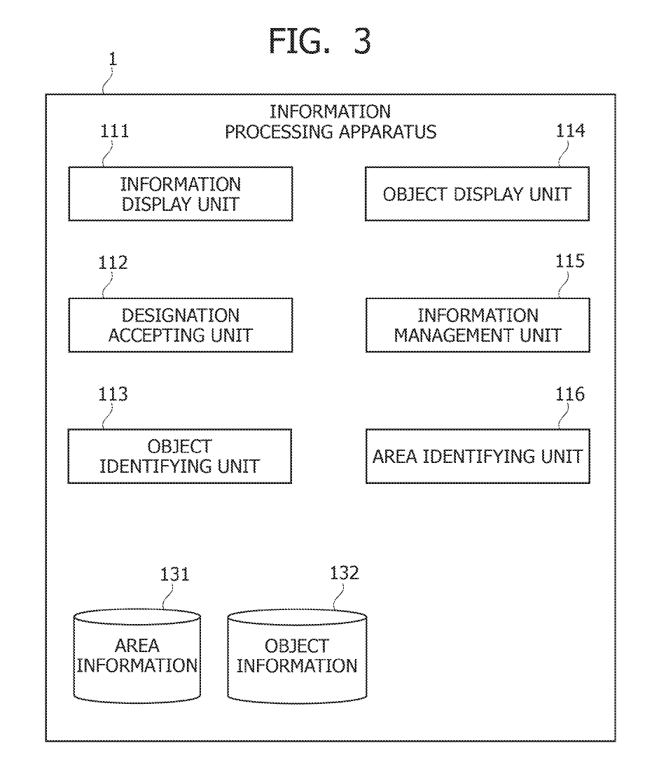

Next, functions of the information processing apparatus 1 will be described. FIG. 3 is a block diagram of functions of an information processing apparatus. The information processing apparatus illustrated in FIG. 3 may be the information processing apparatus 1 illustrated in FIG. 1.

In the information processing apparatus 1, hardware such as the CPU 101 and the memory 102 and the program 110 organically cooperate with each other. Thereby, as illustrated in FIG. 3, the information processing apparatus 1 implements various kinds of functions including an information display unit 111, a designation accepting unit 112, an object identifying unit 113, an object display unit 114, an information management unit 115, and an area identifying unit 116.

Furthermore, the information processing apparatus 1 stores area information 131 and object information 132 in the information storage area 130 as illustrated in FIG. 3.

The area information 131 is information regarding each of plural areas, for example. For example, the area information 131 includes label information that is information representing a name or the like defined about each of the plural areas, number-of-objects information that represents the number of objects OB displayed in each of the plural areas, and coordinate information that represents the range (coordinates) of the plural areas. A concrete example of the area information 131 will be described later.

The object information 132 is information regarding each object OB, for example. For example, the object information 132 is information including position information that represents the display position (coordinates) of each object OB and display area information that represents the area in which each object OB is displayed. A concrete example of the object information 132 will be described later.

The information display unit 111 displays the label information that represents each of the plural areas and so forth on the display surface 11 of the desk. For example, the information display unit 111 refers to the area information 131 stored in the information storage area 130 and displays the label information and the number-of-objects information corresponding to a respective one of areas in each of the respective one of the plural areas in the display surface 11 of the desk.

Furthermore, the information display unit 111 displays the objects OB corresponding to a respective one of areas in the respective one of the plural areas on the display surface 11 of the desk. For example, the information display unit 111 refers to the object information 132 stored in the information storage area 130 and displays the objects OB corresponding to the respective one of the areas in the respective one of the plural areas on the display surface 11 of the desk.

The designation accepting unit 112 accepts designation of a first area and a second area in the plural areas. For example, if the participant 21 carries out designation of the first area and the second area and designation of intention of merging the first area and the second area and defining a new area (third area) by using a pen-type input apparatus, the designation accepting unit 112 accepts these kinds of designation.

The object identifying unit 113 refers to the object information 132 stored in the information storage area 130 and identifies the first objects OBa displayed in the first area about which the designation accepting unit 112 has accepted designation and the second objects OBb displayed in the second area.

The object display unit 114 displays information that represents the third area on the display surface 11 of the desk. For example, the object display unit 114 refers to the area information 131 stored in the information storage area 130 and generates the label information and the number-of-objects information corresponding to the third area from the label information and the number-of-objects information corresponding to each of the first area and the second area to display the generated label information and number-of-objects information.

Furthermore, the object display unit 114 displays the first objects OBa and the second objects OBb identified by the object identifying unit 113 in the third area on the display surface 11 of the desk.

The information management unit 115 updates the area information 131 and the object information 132 stored in the information storage area 130 in such a manner that the first objects OBa and the second objects OBb correspond to the third area.

Moreover, the designation accepting unit 112 accepts designation of a dividing position at which a specific area on the display surface 11 of the desk is divided into plural areas (hereinafter, referred to also as divided areas). For example, if the participant 21 carries out designation of the dividing position in the specific area by using a pen-type input apparatus, the designation accepting unit 112 accepts this designation.

When the designation accepting unit 112 accepts the designation of the dividing position, the object identifying unit 113 refers to the object information 132 stored in the information storage area 130 and identifies the objects OB displayed in the specific area and the display position of each object OB.

The area identifying unit 116 identifies the divided area in which each of the objects OB identified by the object identifying unit 113 is included in the plural divided areas divided from the specific area based on the display position of each object OB identified by the object identifying unit 113 and the dividing position about which the designation accepting unit 112 has accepted designation.

The object display unit 114 displays information that represents the plural divided areas on the display surface 11 of the desk. For example, the object display unit 114 refers to the area information 131 stored in the information storage area 130 and generates the label information corresponding to each of the plural divided areas from the label information corresponding to the specific area to display the generated label information.

Furthermore, the object display unit 114 displays the objects OB corresponding to a respective one of areas in the objects OB identified by the object identifying unit 113 in the respective one of the plural divided areas on the display surface 11 of the desk.

The information management unit 115 updates the area information 131 and the object information 132 stored in the information storage area 130 in such a manner that the objects OB corresponding to the respective one of the areas in the objects OB identified by the object identifying unit 113 correspond to the respective one of the plural divided areas.

[Outline of First Embodiment]

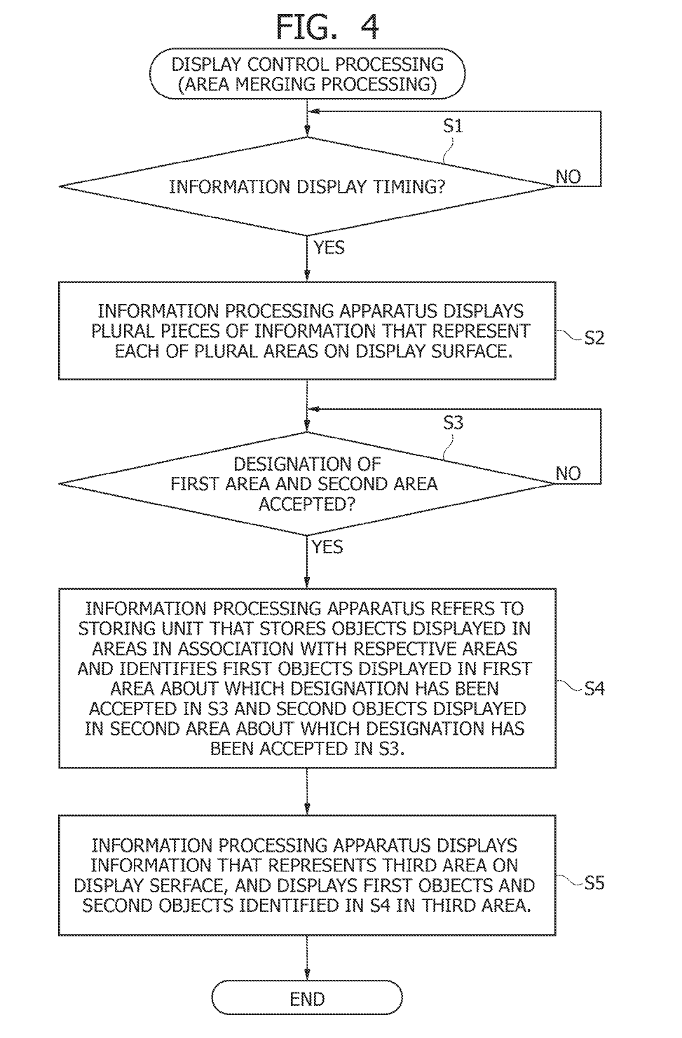

Next, the outline of a first embodiment will be described. FIG. 4 to FIG. 9 are flowchart diagrams for explaining outlines of display control processing in the first embodiment.

[Outline of Area Merging Processing (1)]

First, the outline of processing of merging areas (hereinafter, referred to also as area merging processing) in the display control processing will be described. FIG. 4 is a flowchart diagram for explaining an outline of area merging processing.

As illustrated in FIG. 4, the information processing apparatus 1 waits until the information display timing has come (NO of S1). The information display timing may be a timing when the participant 21 has made an input that represents intention of displaying each of plural pieces of information representing the respective areas by using a pen-type input apparatus, for example.

Then, if the information display timing has come (YES of S1), the information processing apparatus 1 displays plural pieces of information that represent each of plural areas on the display surface 11 (S2).

Thereafter, the information processing apparatus 1 waits until accepting designation of a first area and a second area in the plural areas (NO of S3).

Then, if designation of the first area and the second area is accepted (YES of S3), the information processing apparatus 1 refers to the information storage area 130 that stores the objects OB displayed in the areas in association with the respective areas and identifies the first objects OBa displayed in the first area about which the designation has been accepted in the processing of S3 and the second objects OBb displayed in the second area about which the designation has been accepted in the processing of S3 (S4).

For example, the information processing apparatus 1 refers to the object information 132 stored in the information storage area 130 and identifies the first objects OBa and the second objects OBb.

Thereafter, the information processing apparatus 1 displays information that represents a third area on the display surface 11 and displays the first objects OBa and the second objects OBb identified in the processing of S4 in the third area (S5).

For example, the information processing apparatus 1 refers to the area information 131 stored in the information storage area 130 and identifies the information that represents the third area. Then, the information processing apparatus 1 displays the identified information that represents the third area and the first objects OBa and the second objects OBb.

For example, the information processing apparatus 1 defines the plural areas on the display surface 11 in advance based on information input by the participant 21. Then, the information processing apparatus 1 stores the information that represents each of the plural areas in the storing apparatus 1a in advance.

Thereafter, for example, if an instruction to merge the first area and the second area in the plural areas and define the third area is made, the information processing apparatus 1 refers to the information stored in the information storage area 130 in advance. Then, the information processing apparatus 1 identifies the objects OB displayed in a respective one of the first area and the second area (first objects OBa and second objects OBb) and displays each of the identified objects OB in the third area.

This allows the information processing apparatus 1 to manage each of the pieces of information that represent the respective areas defined by the participant 21. Thus, it becomes possible for the participant 21 to easily merge areas without managing the pieces of information that represent the respective areas for oneself.

The third area may be an area obtained by combining the first area and the second area or may be an area different from the first area and the second area. Furthermore, the first area and the second area may be areas adjacent to each other on the display surface 11 or may be areas that are not adjacent to each other on the display surface 11.

[Outline of Area Dividing Processing]

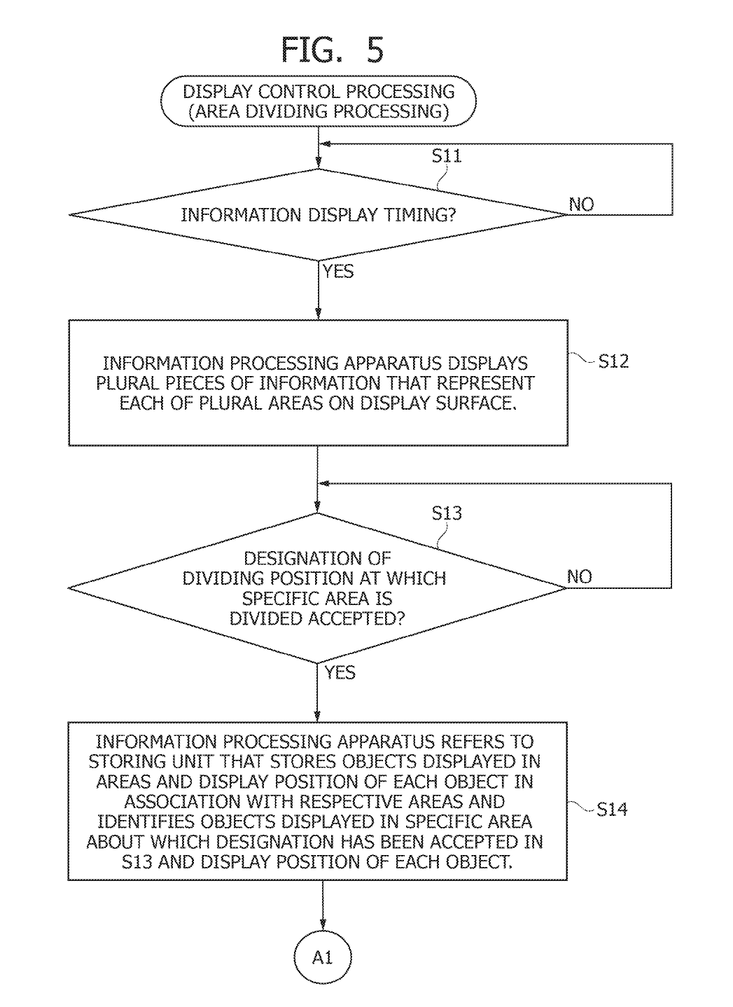

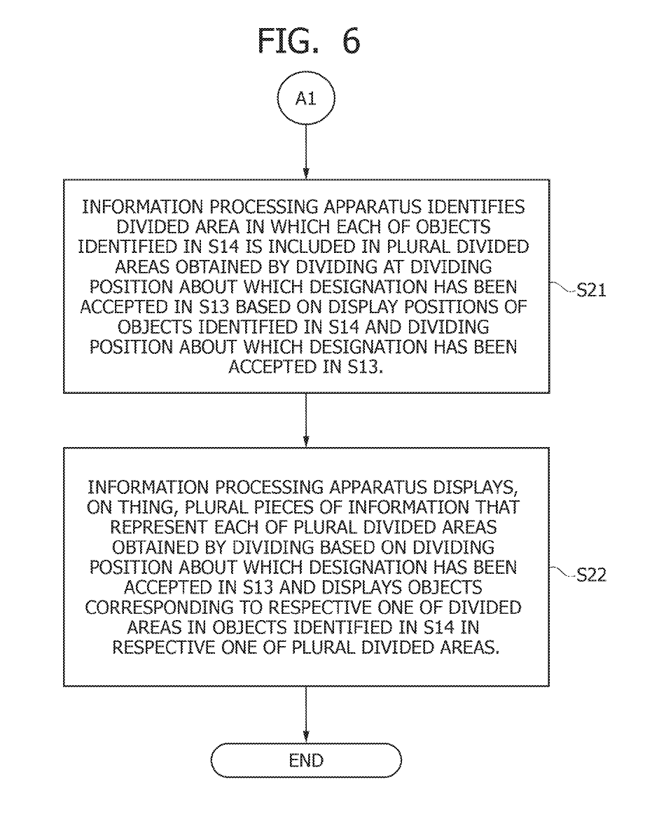

Next, the outline of processing of dividing an area (hereinafter, referred to also as area dividing processing) in the display control processing will be described. FIG. 5 and FIG. 6 are flowchart diagrams for explaining outlines of area dividing processing.

As illustrated in FIG. 5, the information processing apparatus 1 waits until the information display timing has come (NO of S11). Then, if the information display timing has come (YES of S11), the information processing apparatus 1 displays plural pieces of information that represent each of plural areas on the display surface 11 (S12).

Thereafter, the information processing apparatus 1 waits until accepting designation of a dividing position at which a specific area in the plural areas for which the plural pieces of information have been displayed in the processing of S12 is divided (NO of S13).

Then, if designation of the dividing position at which the specific area is divided is accepted (YES of S13), the information processing apparatus 1 refers to the information storage area 130 that stores the objects OB displayed in the areas and the display position of each object OB in association with the respective areas and identifies the objects OB displayed in the specific area about which the designation has been accepted in the processing of S13 and the display position of each object OB (S14).

For example, the information processing apparatus 1 refers to the object information 132 stored in the information storage area 130 and identifies the objects OB displayed in the specific area and the display position of each object OB.

Subsequently, as illustrated in FIG. 6, the information processing apparatus 1 identifies the divided area in which each of the objects OB identified in the processing of S14 is included in plural divided areas obtained by dividing based on the dividing position about which the designation has been accepted in the processing of S13 based on the display positions of the objects OB identified in the processing of S14 and the dividing position about which the designation has been accepted in the processing of S13 (S21).

Thereafter, the information processing apparatus 1 displays, on the display surface 11, plural pieces of information that represent each of the plural divided areas obtained by dividing based on the dividing position about which the designation has been accepted in the processing of S13 and displays the objects OB corresponding to a respective one of the divided areas in the objects OB identified in the processing of S14 in the respective one of the plural divided areas (S22).

For example, the information processing apparatus 1 refers to the area information 131 stored in the information storage area 130 and identifies information that represents the specific area. Then, based on the identified information, the information processing apparatus 1 generates the pieces of information that represent each of the plural divided areas obtained by dividing based on the dividing position. Thereafter, regarding each of the plural divided areas obtained by dividing based on the dividing position, the information processing apparatus 1 displays the generated information that represents a respective one of the divided areas and the objects OB corresponding to the respective one of the divided areas.

For example, if an instruction to divide the specific area is made, the information processing apparatus 1 refers to the area information 131 and the object information 132 stored in the information storage area 130 in advance and displays the information that represents each divided area and the object OB corresponding to each divided area.

This allows the participant 21 to easily divide an area without managing the information that represents the respective areas for oneself.

[Outline of Object Disposing Processing]

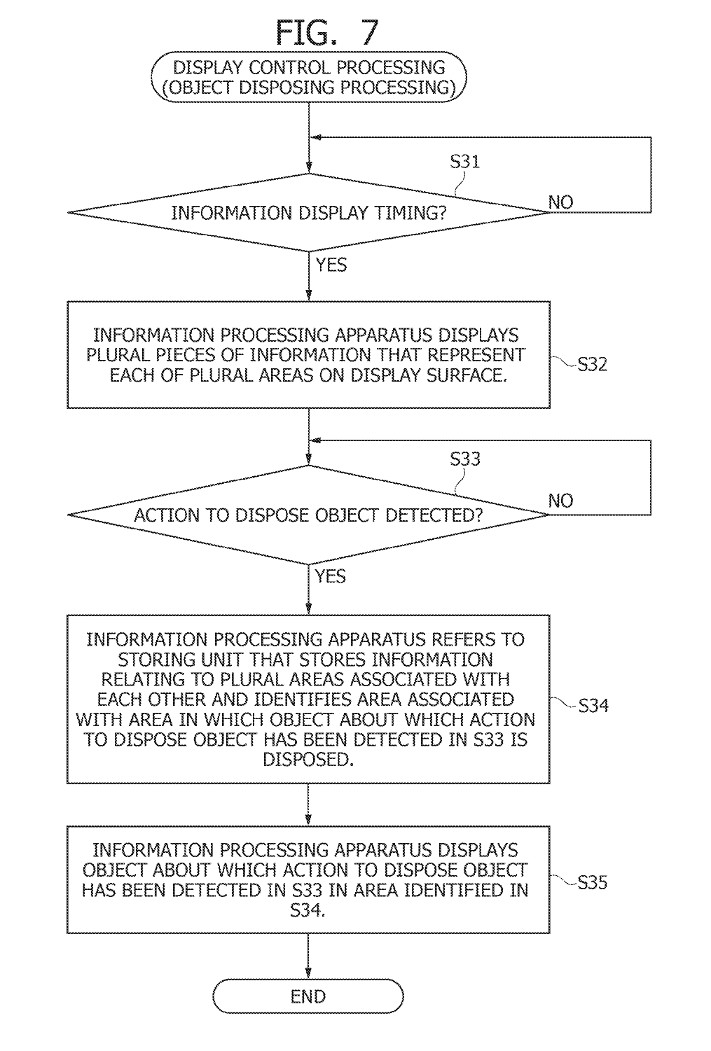

Next, the outline of processing of disposing a new object OB in any area (hereinafter, referred to also as object disposing processing) in the display control processing will be described. FIG. 7 is a flowchart diagram for explaining an outline of object disposing processing.

As illustrated in FIG. 7, the information processing apparatus 1 waits until the information display timing has come (NO of S31). Then, if the information display timing has come (YES of S31), the information processing apparatus 1 displays plural pieces of information that represent each of plural areas on the display surface 11 (S32).

Thereafter, the information processing apparatus 1 waits until detecting action to dispose the object OB in any area in the plural areas (NO of S33).

Then, if action to dispose the object OB in any area is detected (YES of S33), the information processing apparatus 1 refers to the information storage area 130 that stores information relating to plural areas associated with each other and identifies the area associated with the area in which the object OB about which the action to dispose the object OB has been detected in the processing of S33 is disposed (S34).

For example, the information processing apparatus 1 refers to the area information 131 stored in the information storage area 130 and identifies the area including the position at which the new object OB is disposed.

Thereafter, the information processing apparatus 1 displays the object OB about which the action to dispose the object OB has been detected in the processing of S33 in the area identified in the processing of S34 (S35).

This allows the participant 21 to easily dispose the new object OB in the respective areas without managing the information that represents the respective areas for oneself.

[Outline of Number-of-Disposed-Objects Calculation Processing]

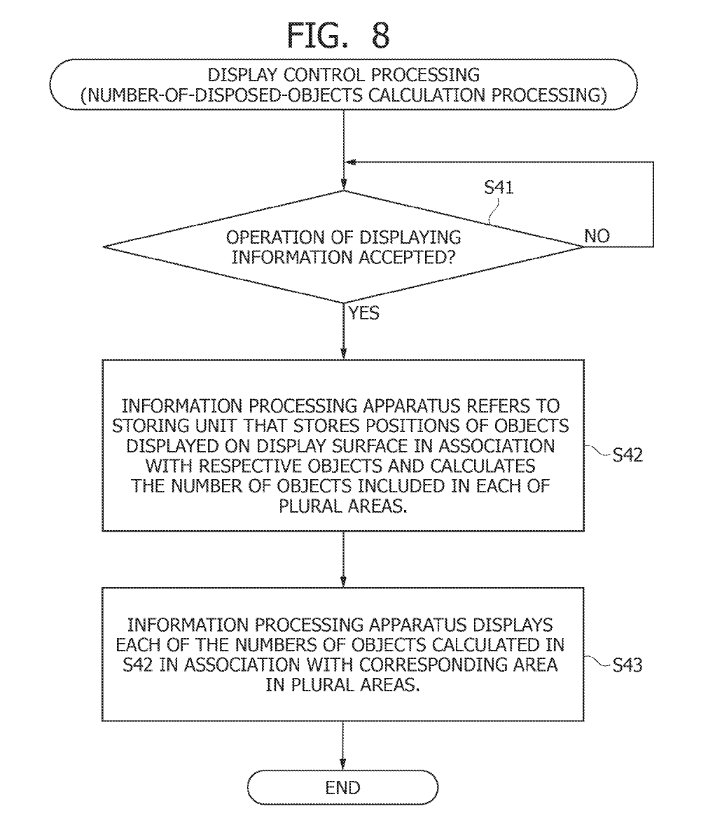

Next, the outline of processing of calculating the number of objects OB displayed (disposed) in each area (hereinafter, referred to also as number-of-disposed-objects calculation processing) in the display control processing will be described. FIG. 8 is a flowchart diagram for explaining an outline of number-of-disposed-objects calculation processing.

As illustrated in FIG. 8, the information processing apparatus 1 waits until accepting operation of displaying plural pieces of information that represent each of plural areas on the display surface 11 (NO of S41).

For example, the information processing apparatus 1 waits until the participant 21 makes an input that represents intention of displaying information representing the respective areas by using a pen-type input apparatus or the like.

Then, if operation of displaying plural pieces of information that represent each of plural areas on the display surface 11 is accepted (YES of S41), the information processing apparatus 1 refers to the information storage area 130 that stores the positions of the objects OB displayed on the display surface 11 in association with the respective objects OB and calculates the number of objects OB included in each of the plural areas (S42).

For example, the information processing apparatus 1 refers to the object information 132 stored in the information storage area 130 and calculates the number of objects OB included in each area.

Thereafter, the information processing apparatus 1 displays each of the numbers of objects OB calculated in the processing of S42 in association with the corresponding area in the plural areas (S43).

This allows the participant 21 to easily calculate the number of objects included in each area without managing the information that represents the respective areas for oneself.

[Outline of Area Merging Processing (2)]

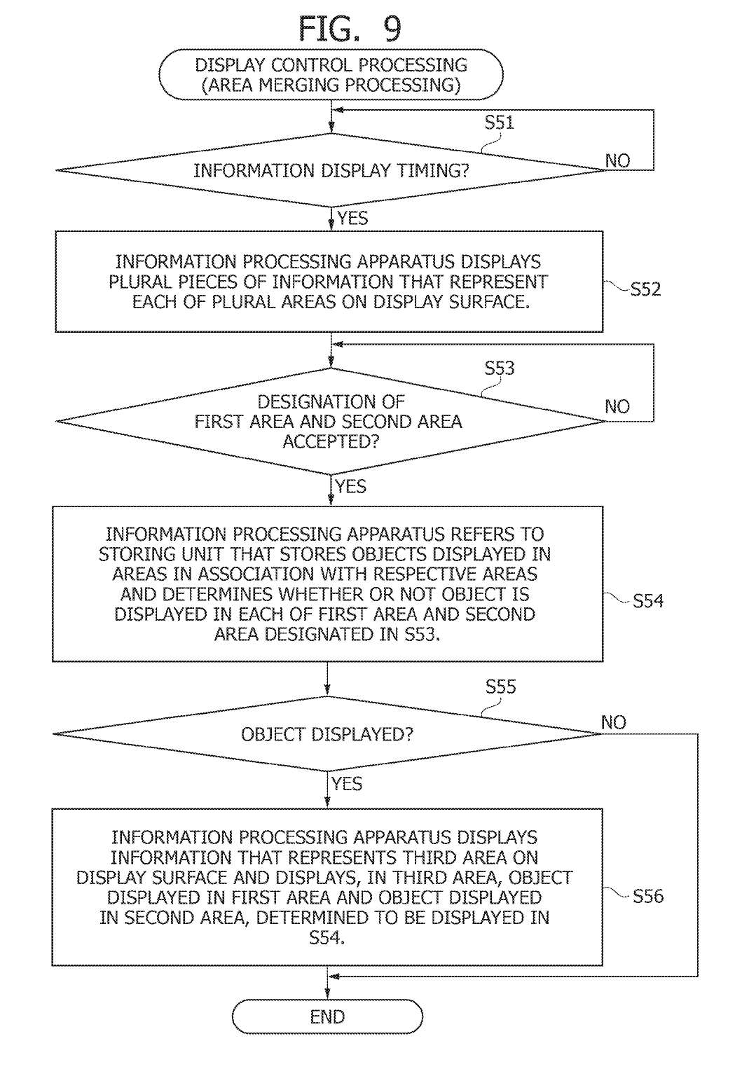

Next, the outline of another kind of area merging processing in the display control processing will be described. FIG. 9 is a flowchart diagram for explaining an outline of the other kind of area merging processing.

As illustrated in FIG. 9, the information processing apparatus 1 waits until the information display timing has come (NO of S51). Then, if the information display timing has come (YES of S51), the information processing apparatus 1 displays plural pieces of information that represent each of plural areas on the display surface 11 (S52).

Thereafter, the information processing apparatus 1 waits until accepting designation of a first area and a second area in the plural areas (NO of S53).

Then, if designation of the first area and the second area is accepted (YES of S53), the information processing apparatus 1 refers to the information storage area 130 that stores the objects OB displayed in the areas in association with the respective areas and determines whether or not the object OB is displayed in each of the first area and the second area designated in the processing of S53 (S54).

For example, the information processing apparatus 1 refers to the object information 132 stored in the information storage area 130 and determines whether or not the object OB is displayed in each of the first area and the second area.

If determining that the object OB is displayed in each of the first area and the second area designated in the processing of S53 as a result (YES of S55), the information processing apparatus 1 displays information that represents a third area on the display surface 11 and displays, in the third area, the object OB displayed in the first area and the object OB displayed in the second area, determined to be displayed in the processing of S54 (S56).

For example, the information processing apparatus 1 refers to the area information 131 stored in the information storage area 130 and identifies the information that represents the third area. Then, the information processing apparatus 1 displays the identified information that represents the third area and displays the first object OBa and the second object OBb.

On the other hand, if determining that the object OB is not displayed in each of the first area and the second area designated in the processing of S53 (NO of S55), the information processing apparatus 1 does not execute the processing of S56.

This allows the participant 21 to easily merge areas without managing the information that represents the respective areas for oneself.

[Details of First Embodiment]

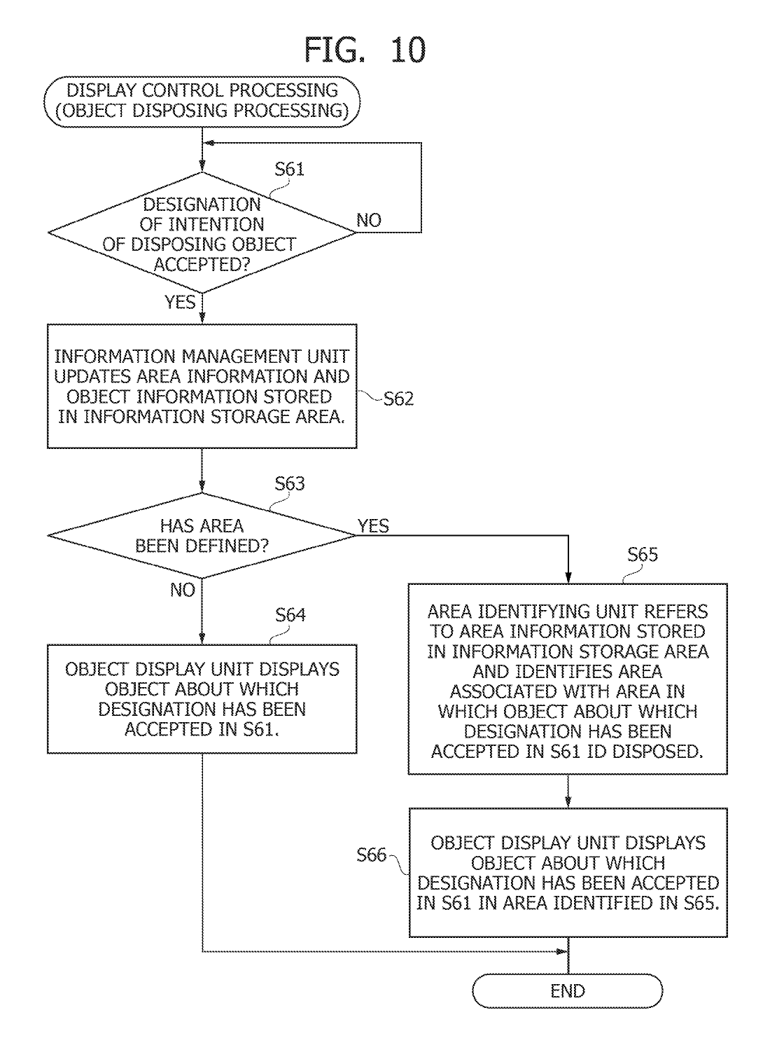

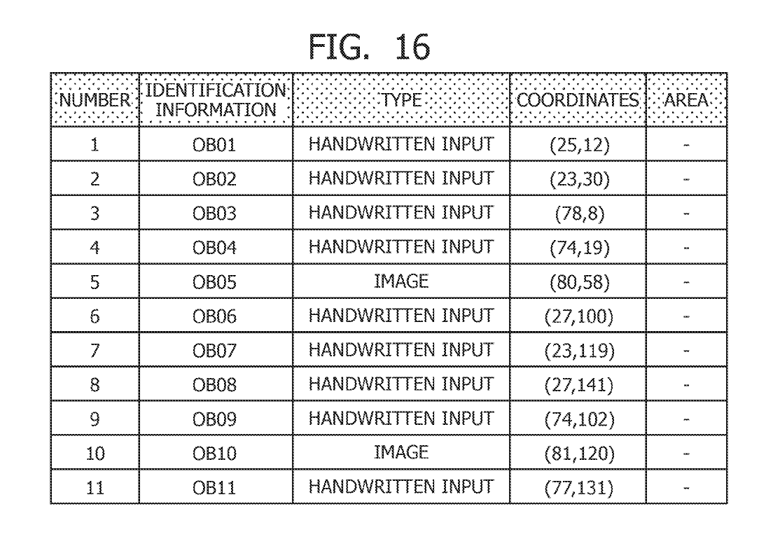

Next, the first embodiment will be described. FIG. 10 to FIG. 15 are flowchart diagrams for explaining details of display control processing in the first embodiment. Furthermore, FIG. 16 to FIG. 35B are diagrams for explaining details of display control processing in the first embodiment. The details of the display control processing of FIG. 10 to FIG. 15 will be described with reference to FIG. 16 to FIG. 35B.

[Details of Object Disposing Processing (1)]

First, details of partial processing in the object disposing processing will be described. FIG. 10 is a flowchart diagram for explaining details of object disposing processing.

As illustrated in FIG. 10, the designation accepting unit 112 of the information processing apparatus 1 waits until accepting designation of intention of disposing the object OB (NO of S61).

For example, the designation accepting unit 112 waits until the participant 21 carries out designation of intention of disposing a new object OB and designation of the display position of the new object OB by using a pen-type input apparatus.

For example, the participant 21 may display a menu screen (not illustrated) for carrying out various kinds of designation on the display surface 11 (the upper surface) of the desk by bringing the tip of the pen-type input apparatus into contact with the display surface 11 of the desk for a certain time. Furthermore, for example, the participant 21 may carry out the designation of intention of disposing the new object OB by selecting an item corresponding to the intention of disposing the new object OB in selectable items included in the displayed menu screen.

Thereafter, if designation of intention of disposing the object OB is accepted (YES of S61), the information management unit 115 of the information processing apparatus 1 updates the area information 131 and the object information 132 stored in the information storage area 130 according to the contents of the designation accepted in the processing of S61 (S62).

If one or more areas have not yet been defined (if the area information 131 is not stored in the information storage area 130), the information management unit 115 carries out only updating of the object information 132 in the processing of S62. In the following, a description will be made about a concrete example of the object information 132 when one or more areas have not yet been defined.

[Concrete Example of Object Information]

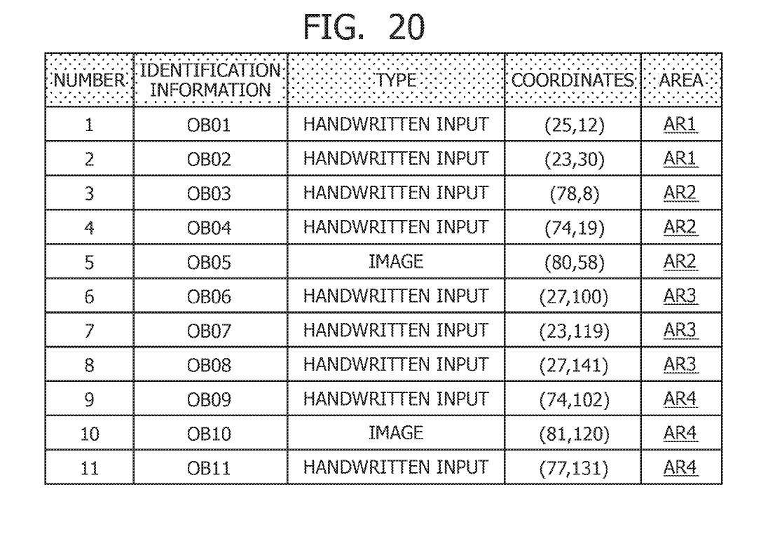

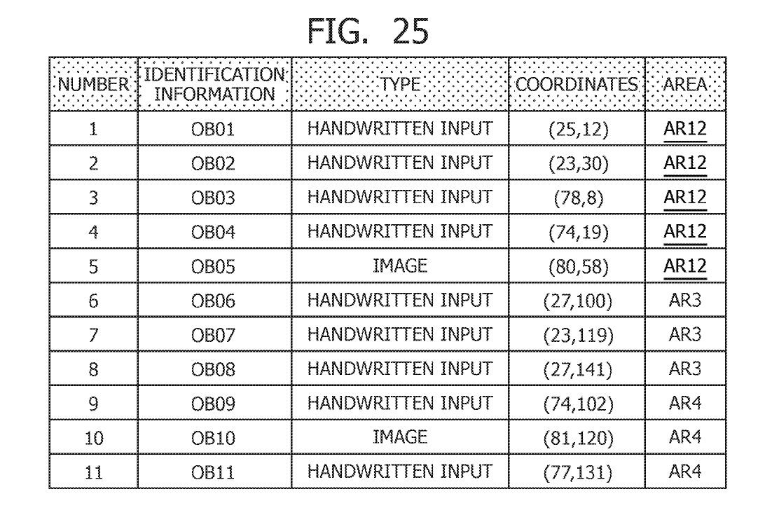

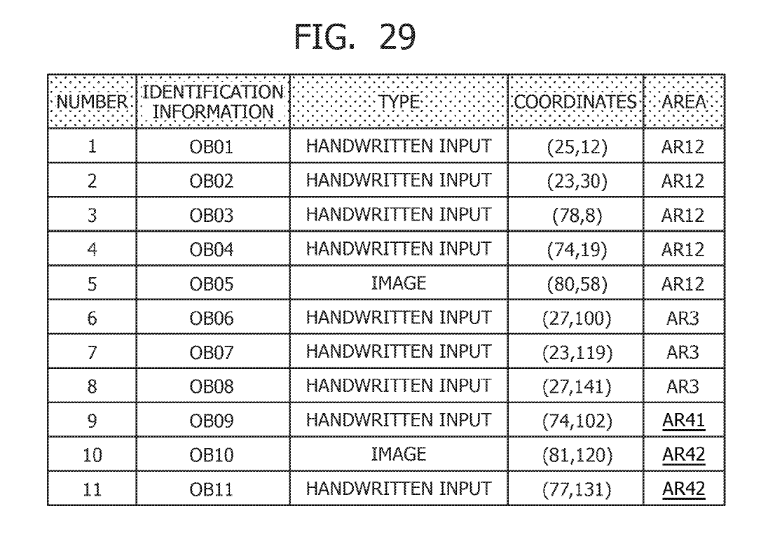

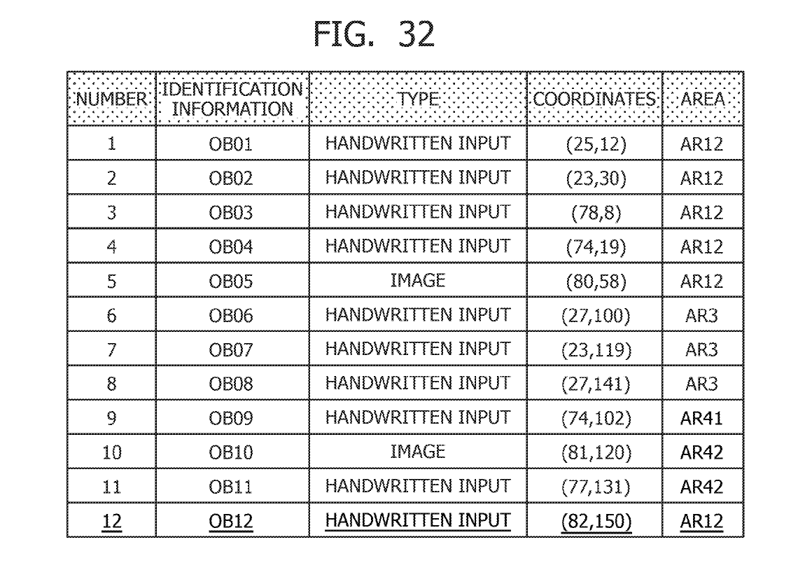

FIG. 16, FIG. 20, FIG. 25, FIG. 29, and FIG. 32 are diagrams for explaining the concrete example of the object information 132. For example, FIG. 16 is a diagram for explaining the concrete example of the object information 132 when one or more areas have not yet been defined.

The object information 132 illustrated in FIG. 16 and so forth has, as items, “number” to identify each piece of information included in the object information 132, “identification information” in which identification information of each object OB is set, and “type” in which the type of each object OB is set. In “type,” “handwritten input” representing that the relevant object is an object generated from characters described by the participant 21 by using a pen-type input apparatus and “image” representing that the relevant object is an object generated from input image data are set, for example. Furthermore, the object information 132 illustrated in FIG. 16 and so forth has, as items, “coordinates” in which the display position (position information) on the display surface 11 about each object OB is set and “area” in which identification information of the area in which each object OB is displayed (display area information) is set.

For example, in the object information 132 illustrated in FIG. 16, in the information whose “number” is “1,” “OB01” is set as “identification information” and “handwritten input” is set as “type” and “(25, 12)” is set as “coordinates.” Furthermore, in the object information 132 illustrated in FIG. 16, for example, in the information whose “number” is “1,” “−” representing that information has not yet been set is set as “area.”

Moreover, in the object information 132 illustrated in FIG. 16, for example, in the information whose “number” is “5,” “OB05” is set as “identification information” and “image” is set as “type” and “(80, 58)” is set as “coordinates.” Furthermore, in the object information 132 illustrated in FIG. 16, for example, in the information whose “number” is “5,” “−” is set as “area.” A description about the other pieces of information included in FIG. 16 is omitted.

Referring back to FIG. 10, the area identifying unit 116 of the information processing apparatus 1 refers to the area information 131 stored in the information storage area 130 and determines whether or not one or more areas have been defined (S63).

If it is determined that one or more areas have not been defined as a result (NO of S63), the object display unit 114 of the information processing apparatus 1 displays the object OB about which the designation has been accepted in the processing of S61 (S64). Thereafter, the information processing apparatus 1 ends the object disposing processing.

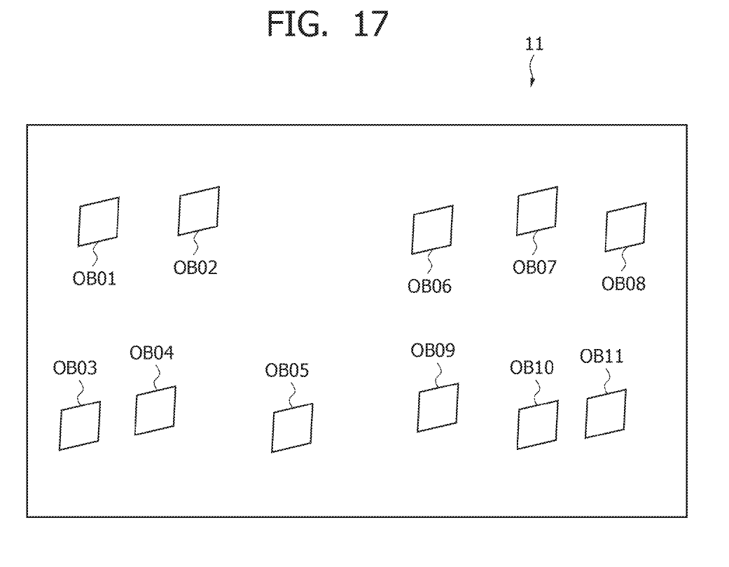

For example, as illustrated in FIG. 17, the object display unit 114 displays the object OB about which the designation has been accepted in the processing of S61 (for example, object OB 11) on the display surface 11 (the upper surface) of the desk. In the example illustrated in FIG. 17, the respective objects OB from an object OB01 to the object OB11 are displayed on the display surface 11 of the desk.

This allows the participant 21 to easily dispose the new object OB in the respective areas without managing the information that represents the respective areas for oneself.

[Area Defining Processing]

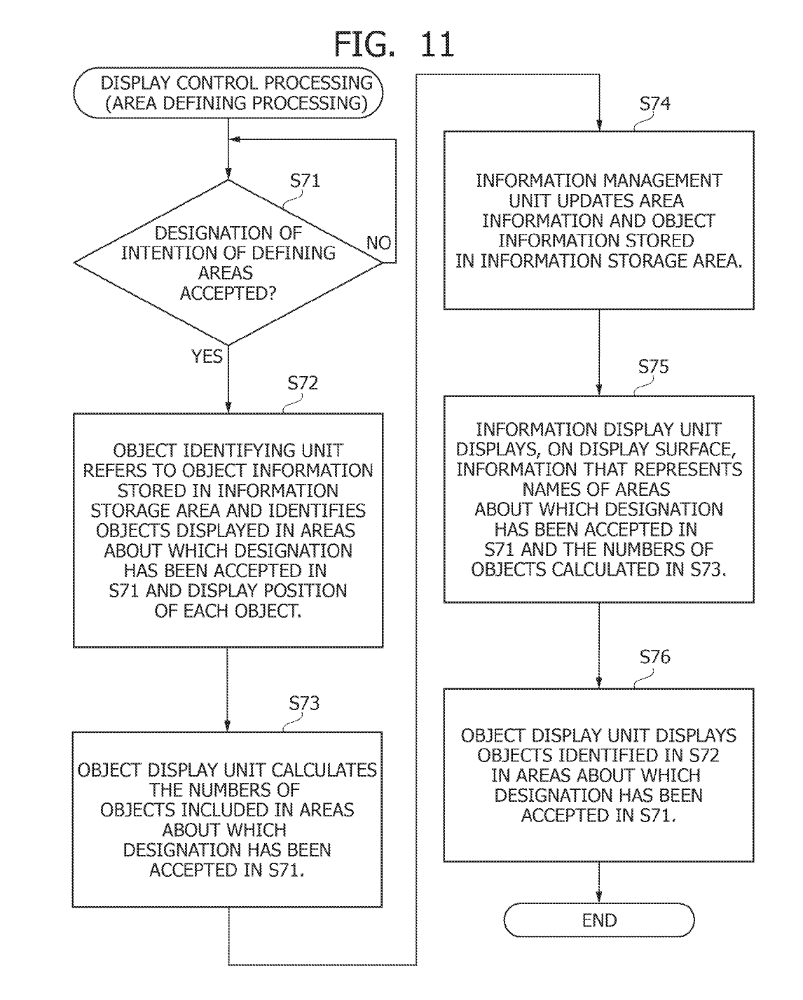

Next, processing of defining areas (hereinafter, referred to also as area defining processing) will be described. For example, FIG. 11 is a flowchart diagram for explaining area defining processing. In the flowchart illustrated in FIG. 11, processing corresponding to details of the number-of-disposed-objects calculation processing is included.

As illustrated in FIG. 11, the designation accepting unit 112 waits until accepting designation of intention of defining areas (NO of S71).

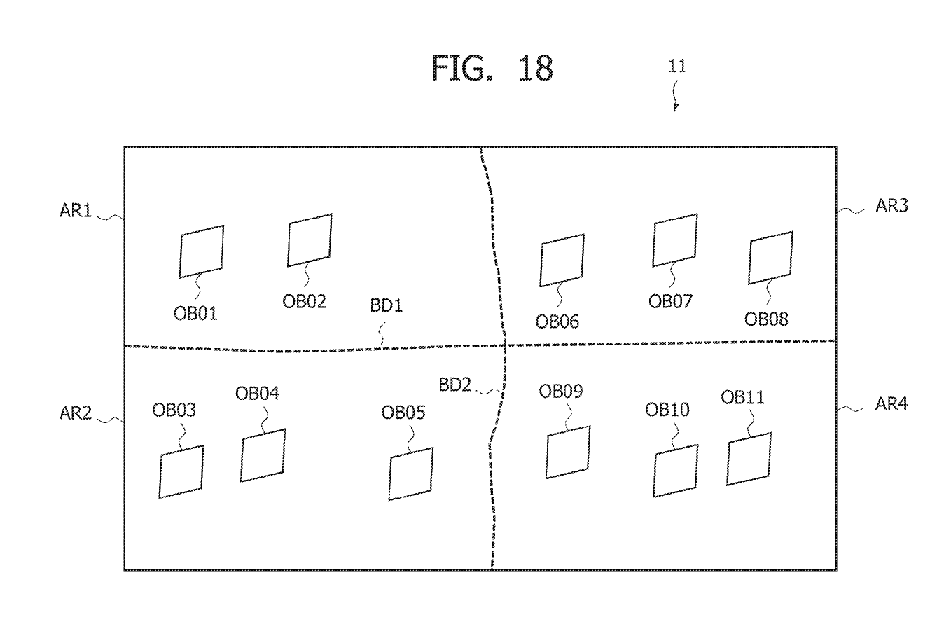

For example, as illustrated in FIG. 18, the designation accepting unit 112 waits until the participant 21 carries out designation of intention of defining areas on the display surface 11 of the desk and designation of a boundary line BD1 and a boundary line BD2 that are boundary line of the areas by using a pen-type input apparatus. In the example illustrated in FIG. 18, the display surface 11 of the desk is divided into area AR1, area AR2, area AR3, and area AR4 due to the designation of the boundary line BD1 and the boundary line BD2.

The pen-type input apparatus may be an apparatus that irradiates the position through which the apparatus passes on the display surface 11 of the desk with an infrared ray, for example. Furthermore, the information processing apparatus 1 may be an apparatus that identifies the coordinates of a locus along which the pen-type input apparatus has moved (for example, coordinates of the boundary line BD1 and the boundary line BD2) through detection, by the sensor apparatus 2, of the infrared ray with which the irradiation is carried out by the pen-type input apparatus.

Thereafter, if designation of intention of defining areas is accepted (YES of S71), the object identifying unit 113 of the information processing apparatus 1 refers to the object information 132 stored in the information storage area 130 and identifies the objects OB displayed in the areas about which the designation has been accepted in the processing of S71 and the display position of each object OB (S72).

For example, the object identifying unit 113 identifies the range of each area (area AR1, area AR2, area AR3, and area AR4) from the coordinates of the circumference of the display surface 11 of the desk and the coordinates of the boundary line BD1 and the boundary line BD2. Then, for example, the object identifying unit 113 identifies the objects OB displayed at the coordinates included in the respective areas by referring to the object information 132 illustrated in FIG. 16 and identifying information set in “identification information” of information in which coordinates included in the range of each area are set in “coordinates.”

Subsequently, the object display unit 114 calculates the numbers of objects OB included in the areas about which the designation has been accepted in the processing of S71 (S73).

For example, in the example illustrated in FIG. 18, the object OB01 and the object OB02 are included in the area AR1. Thus, the object display unit 114 identifies “2” as the number of objects OB whose coordinates are included in the range of the area AR1.

Thereafter, the information management unit 115 updates the area information 131 and the object information 132 stored in the information storage area 130 (S74). A concrete example of the area information 131 will be described below.

[Concrete Example of Area Information]

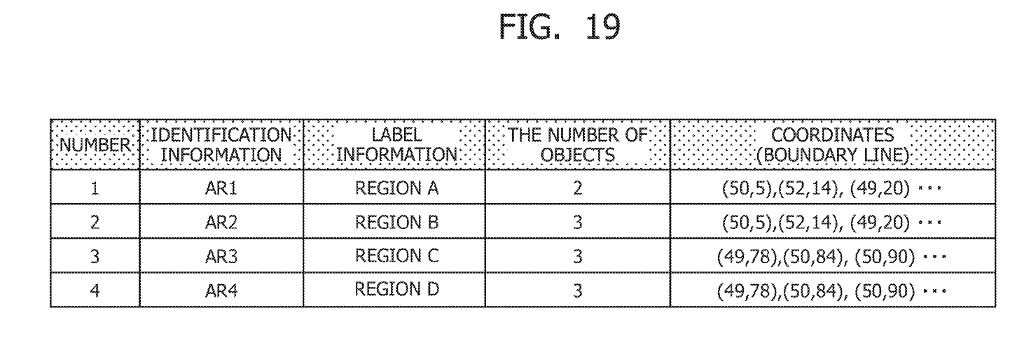

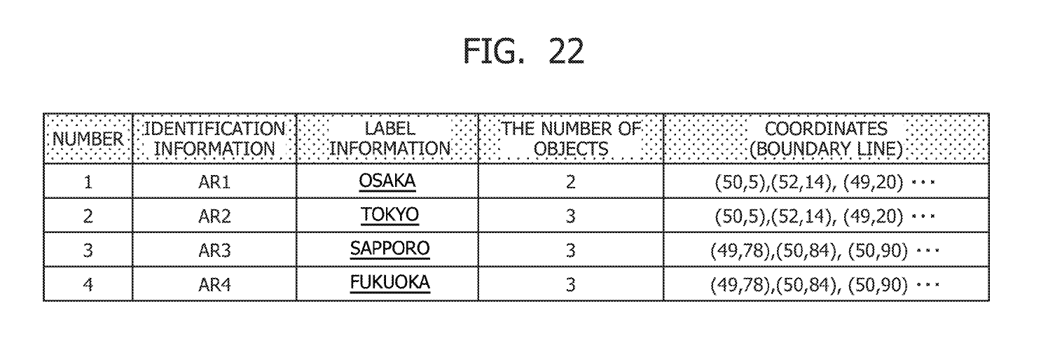

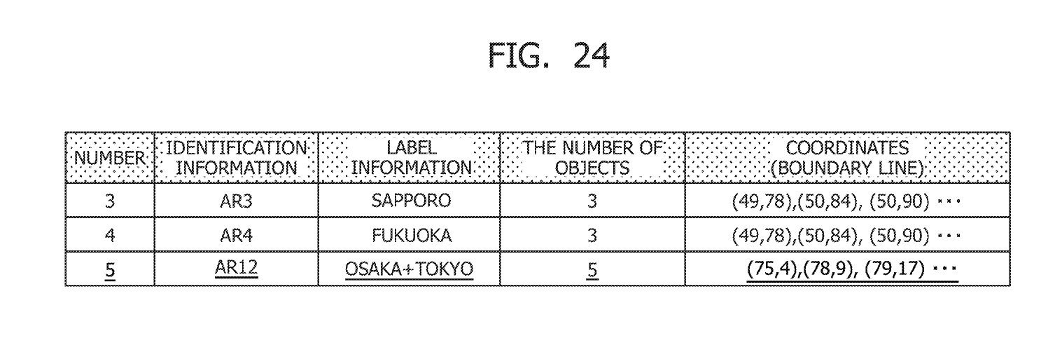

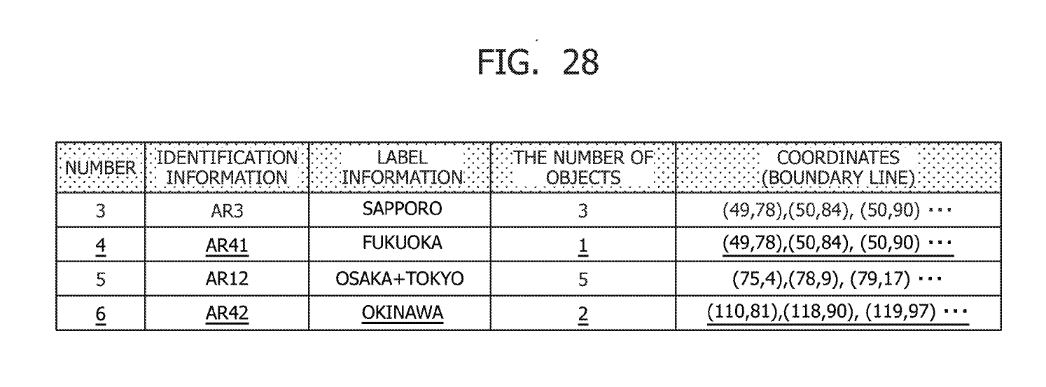

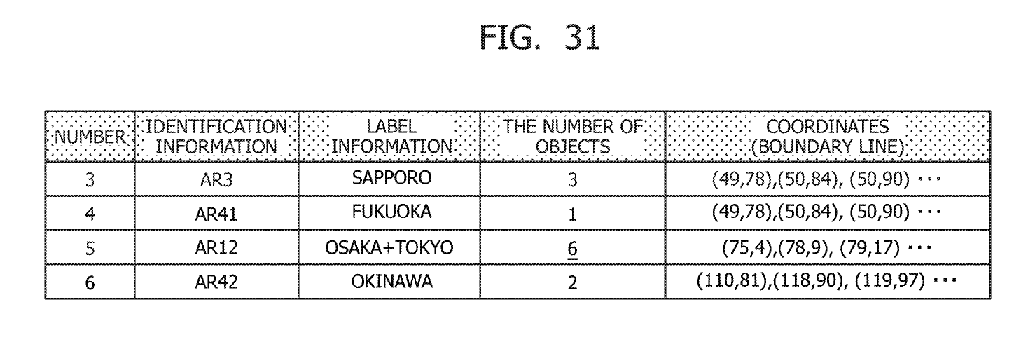

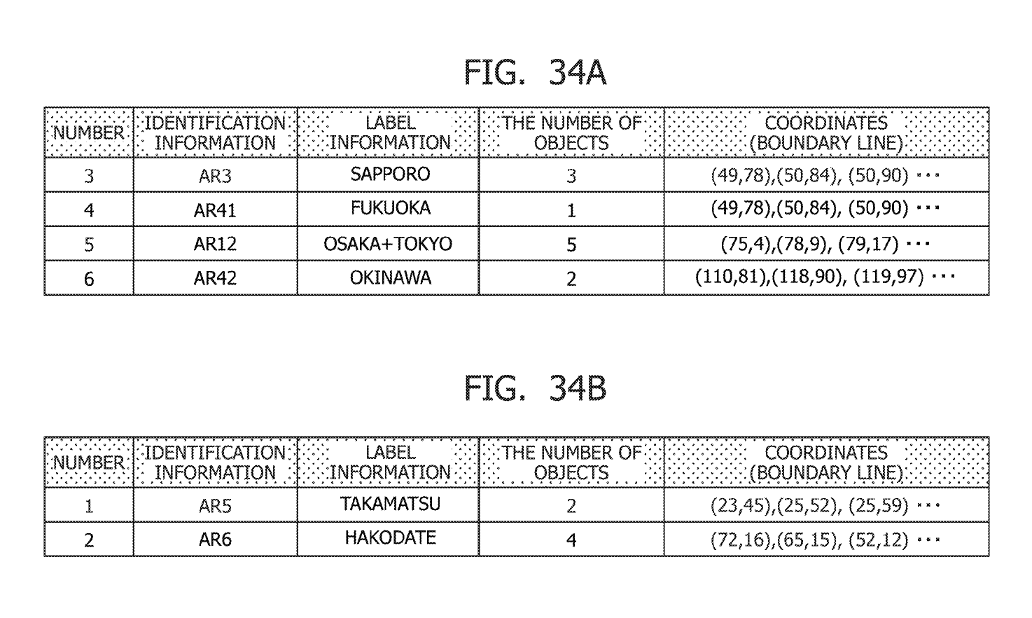

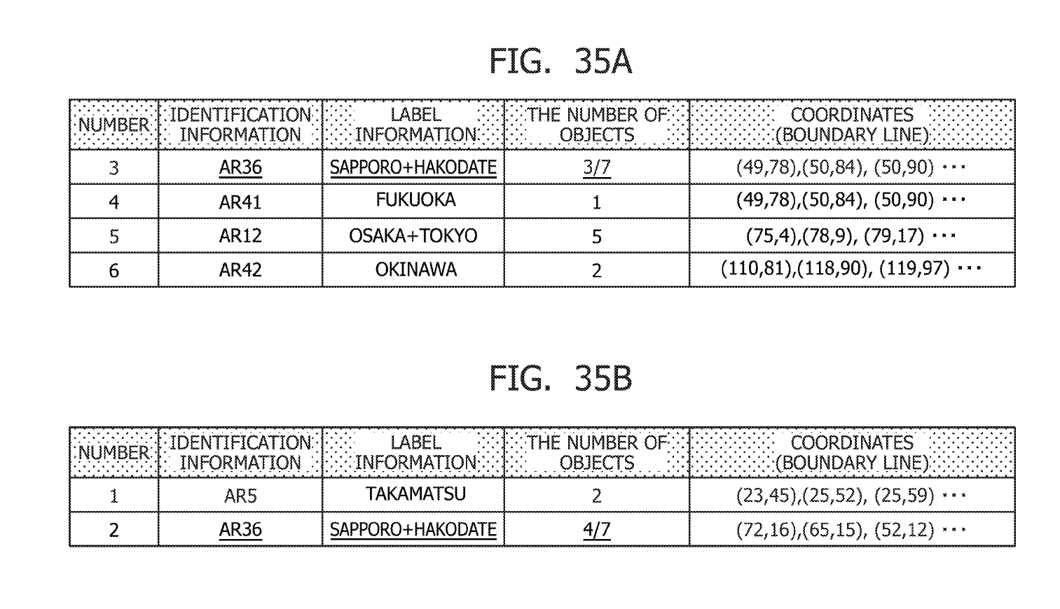

FIG. 19, FIG. 22, FIG. 24, FIG. 28, FIG. 31, FIGS. 34A and 34B, and FIGS. 35A and 35B are diagrams for explaining the concrete example of the area information 131.

The area information 131 illustrated in FIG. 19 and so forth has, as items, “number” to identify each piece of information included in the area information 131, “identification information” in which identification information of each area is set, and “label information” in which information that represents the name of each area (label information) is set. Furthermore, the area information 131 illustrated in FIG. 19 and so forth has, as items, “the number of objects” in which information that represents the number of objects included in each area (number-of-objects information) is set and “coordinates (boundary line)” in which coordinates of the circumference of each area (coordinate information) are set.

For example, in the area information 131 illustrated in FIG. 19, in the information whose “number” is “1,” “AR1” is set as “identification information” and “region A” is set as “label information.” In addition, “2” is set as “the number of objects” and “(50, 5), (52, 14), (49, 20) . . . ” is set as “coordinates (boundary line).”

Furthermore, in the area information 131 illustrated in FIG. 19, in the information whose “number” is “3,” “AR3” is set as “identification information” and “region C” is set as “label information.” In addition, “3” is set as “the number of objects” and “(49, 78), (50, 84), (50, 90) . . . ” is set as “coordinates (boundary line).” A description about the other pieces of information included in FIG. 19 is omitted.

Moreover, in the processing of S74, the information management unit 115 sets the identification information of the area in which each object OB is included in “area” of the object information 132 stored in the information storage area 130.

For example, as represented at underlined parts in FIG. 20, the information management unit 115 sets “AR1” in “area” of each of the pieces of information in which “OB01” and “OB02” are set in “identification information” in the object information 132 illustrated in FIG. 16.

Referring back to FIG. 11, the information display unit 111 of the information processing apparatus 1 displays, on the display surface 11, information that represents the names of the areas about which the designation has been accepted in the processing of S71 and the numbers of objects calculated in the processing of S73 (S75).

Then, the object display unit 114 displays the objects identified in S72 in the areas about which the designation has been accepted in the processing of S71 (S76). Thereafter, the information processing apparatus 1 ends the area defining processing.

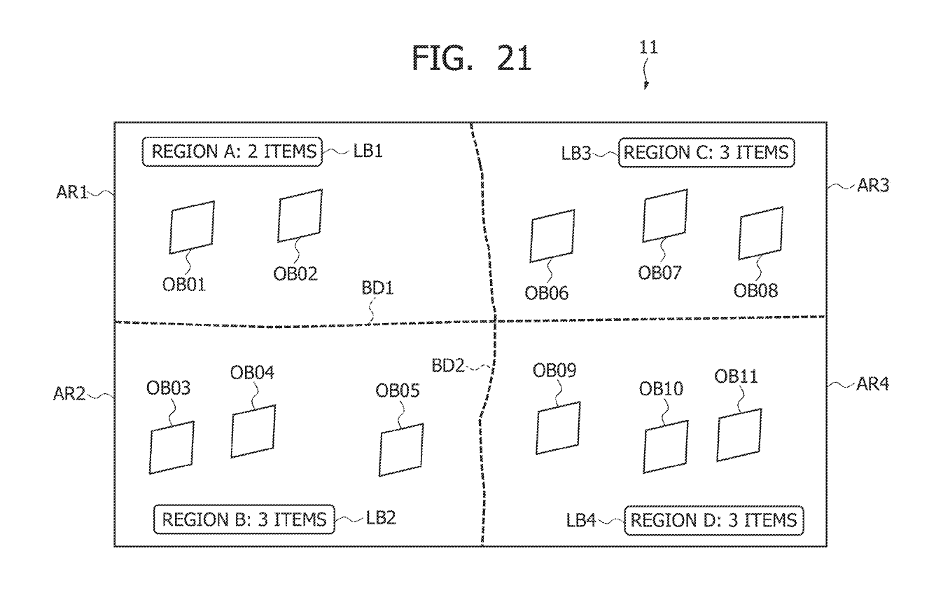

For example, in the area information 131 illustrated in FIG. 19, “region A” is set as “label information” and “2” is set as “the number of objects” in the information in which “AR1” is set in “identification information.” Thus, as illustrated in FIG. 21, the information display unit 111 displays a label LB1 including information that represents “region A” and information that represents “2 items” in the range of the area AR1 on the display surface 11 of the desk, for example.

Furthermore, in the object information 132 illustrated in FIG. 20, “AR1” is set in “area” of each of the pieces of information in which “OB01” and “OB02” are set in “identification information,” for example. Thus, as illustrated in FIG. 21, the object display unit 114 displays the object OB01 and the object OB02 in the range of the area AR1, for example.

This allows the participant 21 to easily define new areas without managing the information that represents the respective areas for oneself.

For example, if an input that represents intention of changing the label information is made from the participant 21, the information management unit 115 may update the area information 131 stored in the information storage area 130 based on the input information.

For example, if information that represents intention of changing the label information of area AR1, area AR2, area AR3, and area AR4 to Osaka, Tokyo, Sapporo, and Fukuoka, respectively, is input, as represented at underlined parts in FIG. 22, the information management unit 115 may update “label information” of the pieces of information in which “identification information” is “AR1,” “AR2,” “AR3,” and “AR4” to “Osaka,” “Tokyo,” “Sapporo,” and “Fukuoka,” respectively.

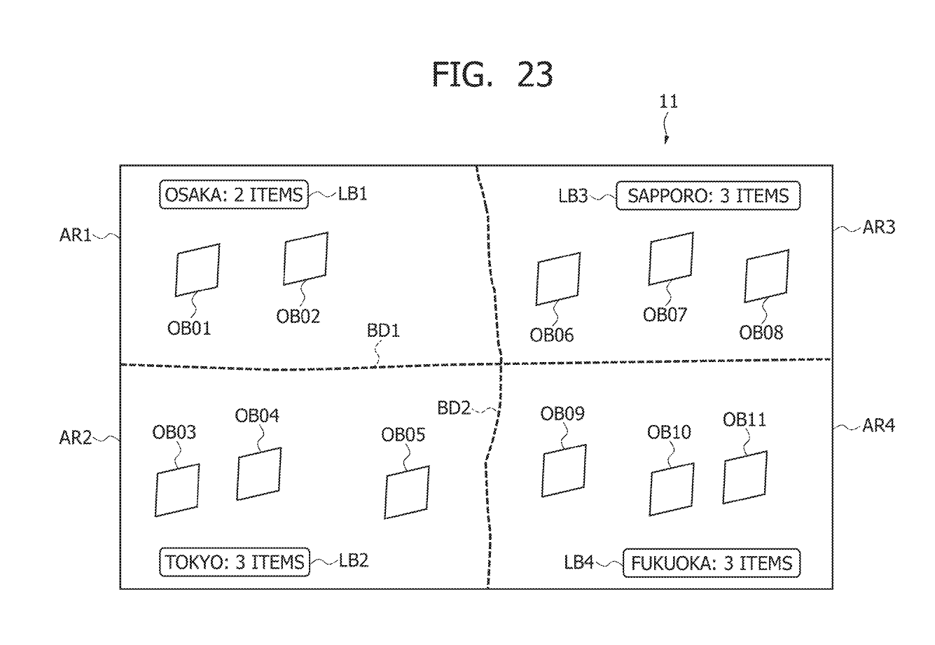

Furthermore, in this case, as illustrated in FIG. 23, the information display unit 111 may display the label LB1 including information that represents “Osaka” and information that represents “2 items” in the range of the area AR1, for example.

[Details of Area Merging Processing]

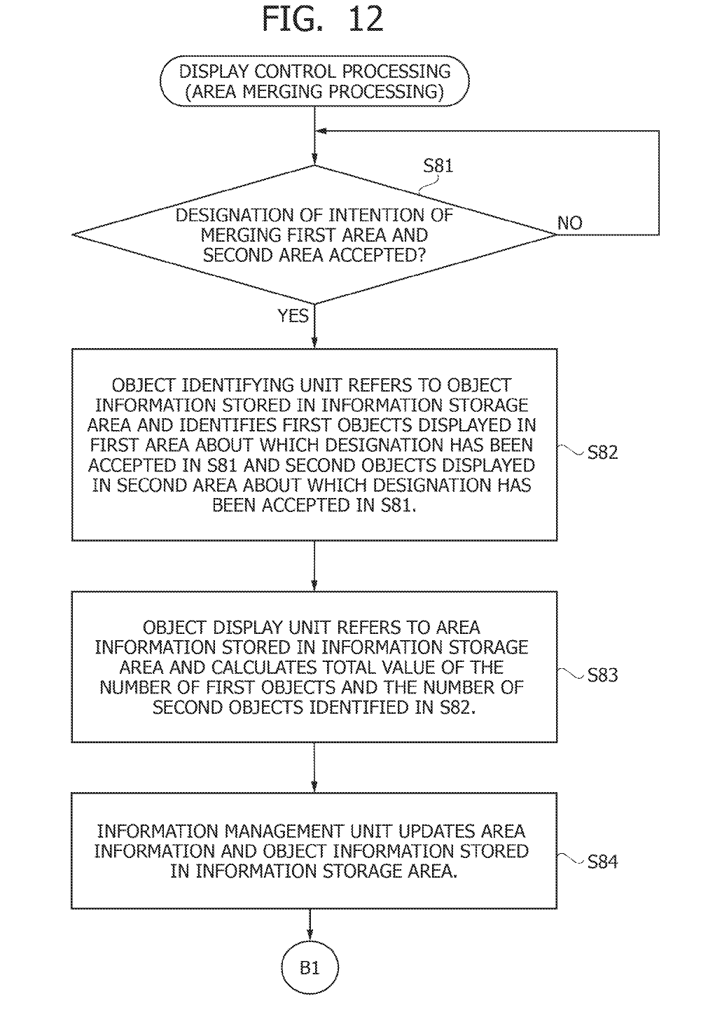

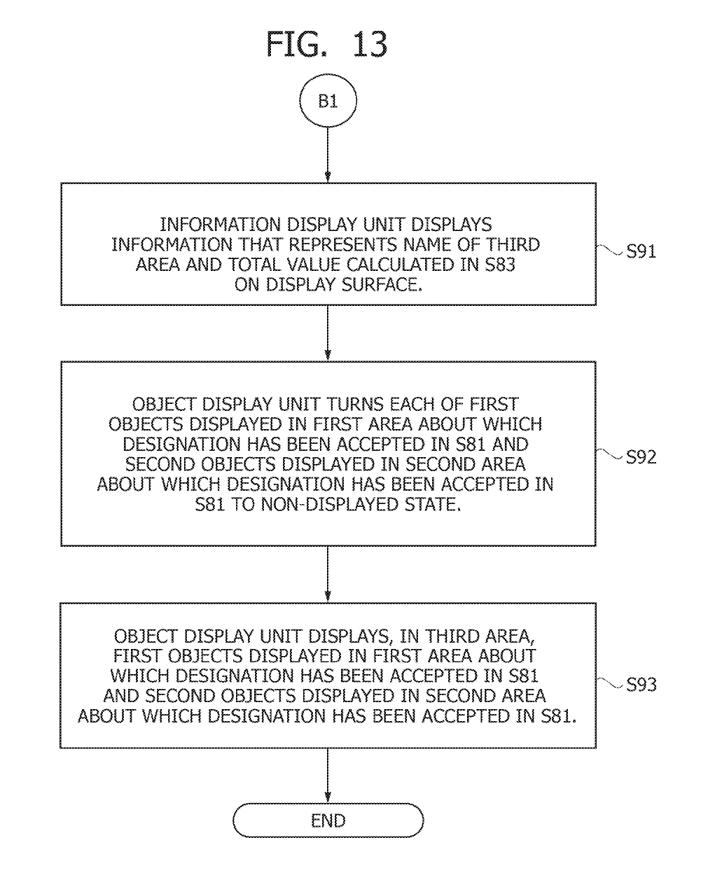

Next, details of the area merging processing will be described. FIG. 12 and FIG. 13 are flowchart diagrams for explaining details of area merging processing. In the flowcharts illustrated in FIG. 12 and FIG. 13, processing corresponding to details of the number-of-disposed-objects calculation processing is included.

As illustrated in FIG. 12, the designation accepting unit 112 waits until accepting designation of intention of merging a first area and a second area in areas that have been defined (NO of S81).

For example, the designation accepting unit 112 waits until the participant 21 carries out designation of intention of merging the first area and the second area by using a pen-type input apparatus.

For example, the participant 21 may carry out the designation of intention of merging the first area and the second area by selecting an item corresponding to the intention of merging areas and an item corresponding to the fact that the areas to be merged are the first area and the second area in selectable items included in a menu screen displayed on the display surface 11 of the desk.

Then, if designation of intention of merging the first area and the second area is accepted (YES of S81), the object identifying unit 113 refers to the object information 132 stored in the information storage area 130 and identifies the first objects OBa displayed in the first area about which the designation has been accepted in the processing of S81 and the second objects OBb displayed in the second area about which the designation has been accepted in the processing of S81 (S82).

For example, if designation of intention of merging the area AR1 and the area AR2 is carried out, the object identifying unit 113 refers to the object information 132 illustrated in FIG. 20 and identifies “OB01” and “OB02,” which are pieces of information set in “identification information” of the pieces of information in which “AR1” is set in “area,” for example. Furthermore, in this case, the object identifying unit 113 refers to the object information 132 illustrated in FIG. 20 and identifies “OB03,” “OB04,” and “OB05,” which are pieces of information set in “identification information” of the pieces of information in which “AR2” is set in “area,” for example.

Then, the object display unit 114 refers to the area information 131 stored in the information storage area 130 and calculates the total value of the number of first objects OBa and the number of second objects OBb identified in the processing of S82 (S83).

For example, the object display unit 114 refers to the area information 131 illustrated in FIG. 22 and figures out “5,” which is the sum of “2” that is information set in “the number of objects” of the information whose “identification information” is “AR1” and “3” that is information set in “the number of objects” of the information whose “identification information” is “AR2.”

Thereafter, the information management unit 115 updates the area information 131 and the object information 132 stored in the information storage area 130 (S84).

For example, as represented at underlined parts in FIG. 24, the information management unit 115 adds information whose “number” is “5” (information obtained by combining the pieces of information whose “number” is “1” and “2”) to the area information 131 illustrated in FIG. 22.

For example, as represented at the underlined parts in FIG. 24, as the information whose “number” is “5,” the information management unit 115 sets “AR12” that is identification information of an area AR12 defined by merging the area AR1 and the area AR2 in “identification information” and sets “Osaka+Tokyo” that is label information obtained by combining Osaka as the label information of the area AR1 and Tokyo as the label information of the area AR2 in “label information.” Furthermore, the information management unit 115 sets “5” figured out in the processing of S83 in “the number of objects” and sets “(75, 4), (78, 9), (79, 17) . . . ” that are coordinates of the circumference of the area AR12 in “coordinates (boundary line)” as the information whose “number” is “5” as represented at the underlined parts in FIG. 24.

Furthermore, as illustrated in FIG. 24, the information management unit 115 deletes the piece of information in which “number” is “1” and “2” from the area information 131 illustrated in FIG. 22, for example.

Moreover, for example, as represented at underlined parts in FIG. 25, the information management unit 115 sets “AR12” in “area” of each of the pieces of information in which “OB01,” “OB02,” “OB03,” “OB04,” and “OB05” are set in “identification information” for the object information 132 illustrated in FIG. 20.

Thereafter, as illustrated in FIG. 13, the information display unit 111 displays information that represents the name of a third area (new area) and the total value calculated in the processing of S83 on the display surface 11 (S91).

Furthermore, the object display unit 114 turns each of the first objects OBa displayed in the first area about which the designation has been accepted in the processing of S81 and the second objects OBb displayed in the second area about which the designation has been accepted in the processing of S81 to the non-displayed state (S92).

Then, the object display unit 114 displays, in the third area, the first objects OBa displayed in the first area about which the designation has been accepted in the processing of S81 and the second objects OBb displayed in the second area about which the designation has been accepted in the processing of S81 (S93).

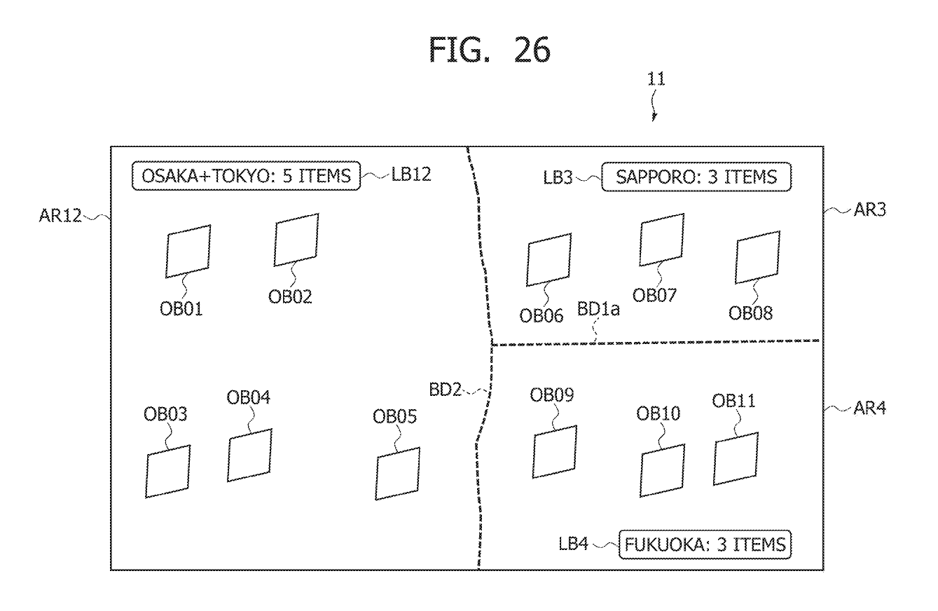

For example, in the information whose “number” is “5” in the area information 131 illustrated in FIG. 24, “Osaka+Tokyo” is set as “label information” and “5” is set as “the number of objects.” Thus, as illustrated in FIG. 26, the information display unit 111 displays a label LB12 including information that represents “Osaka+Tokyo” and information that represents “5 items” in the range of the area AR12 on the display surface 11 of the desk, for example.

Furthermore, in the object information 132 illustrated in FIG. 25, “OB01,” “OB02,” “OB03,” “OB04,” and “OB05” are set as “identification information” of the pieces of information in which “AR12” is set in “area.” Thus, as illustrated in FIG. 26, the object display unit 114 displays the object OB01, the object OB02, the object OB03, the object OB04, and the object OB05 in the range of the area AR12 on the display surface 11 of the desk, for example.

This allows the participant 21 to easily merge areas without managing the information that represents the respective areas for oneself.

[Details of Area Dividing Processing]

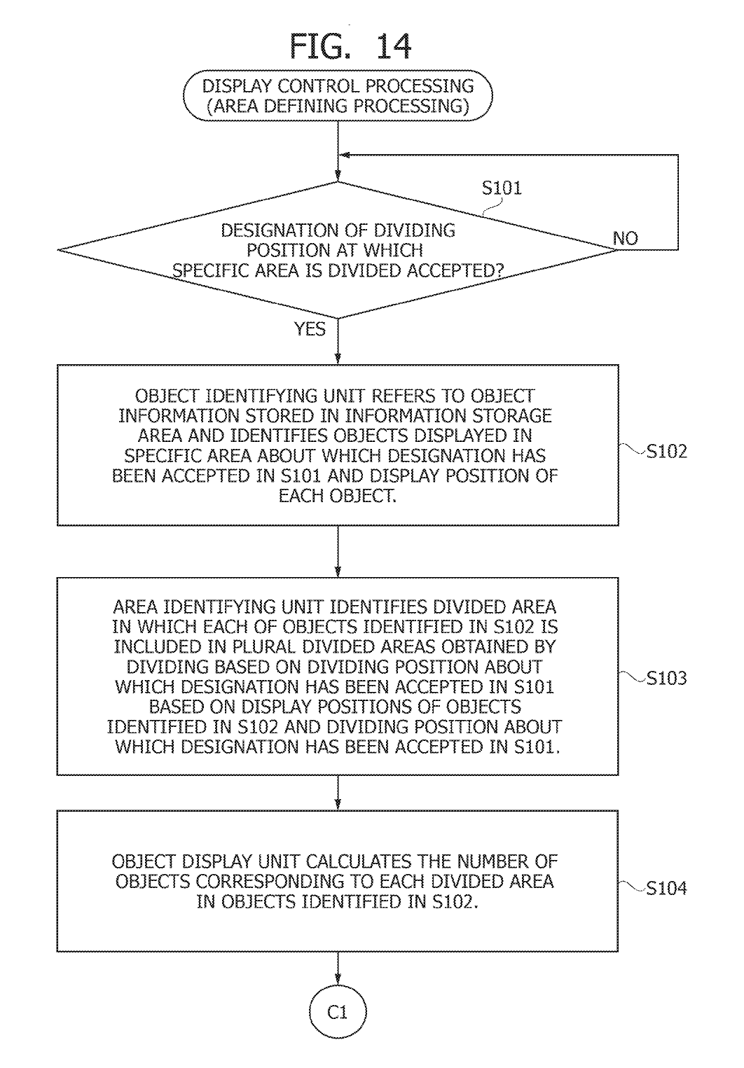

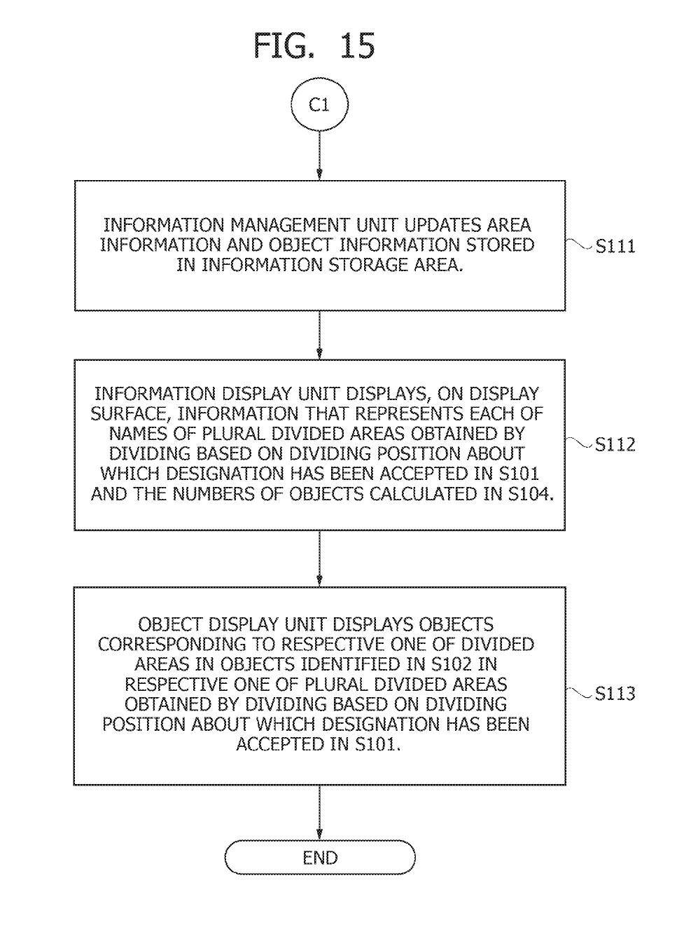

Next, details of the area dividing processing will be described. FIG. 14 and FIG. 15 are flowchart diagrams for explaining details of area dividing processing. In the flowcharts illustrated in FIG. 14 and FIG. 15, processing corresponding to details of the number-of-disposed-objects calculation processing is included.

As illustrated in FIG. 14, the designation accepting unit 112 waits until accepting designation of a dividing position at which a specific area in areas that have been defined is divided (NO of S101).

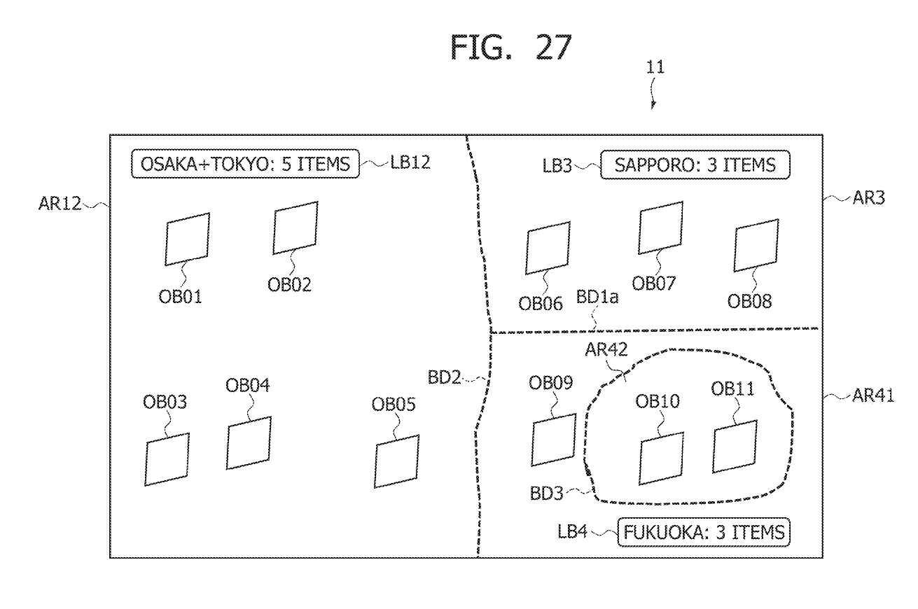

For example, as illustrated in FIG. 27, the designation accepting unit 112 waits until the participant 21 carries out designation of intention of dividing an area on the display surface 11 of the desk and designation of a boundary line BD3 that is a boundary line of areas by using a pen-type input apparatus. In the example illustrated in FIG. 27, the area AR4 on the display surface 11 of the desk is divided into an area AR41 and an area AR42 due to the designation of the boundary line BD3.

Then, if designation of the dividing position at which the specific area is divided is accepted (YES of S101), the object identifying unit 113 refers to the object information 132 stored in the information storage area 130 and identifies the objects OB displayed in the specific area about which the designation has been accepted in the processing of S101 and the display position of each object OB (S102).

For example, if designation of intention of dividing the area AR4 into the area AR41 and the area AR42 is carried out, the object identifying unit 113 refers to the object information 132 illustrated in FIG. 25 and “OB09,” “OB10,” and “OB11,” which are pieces of information set in “identification information” of the pieces of information in which “AR4” is set in “area.” Furthermore, the object identifying unit 113 refers to the object information 132 illustrated in FIG. 25 and identifies “(74, 102),” “(81, 120),” and “(77, 131),” which are pieces of information set in “coordinates” of the pieces of information in which “AR4” is set in “area,” for example.

Then, the area identifying unit 116 identifies the divided area in which each of the objects identified in the processing of S102 is included in plural divided areas obtained by dividing based on the dividing position about which the designation has been accepted in the processing of S101 based on the display positions of the objects identified in the processing of S102 and the dividing position about which the designation has been accepted in the processing of S101 (S103).

For example, if (74, 102) is included in the range of the area AR41 and (81, 120) and (77, 131) are included in the range of the area AR42, the area identifying unit 116 determines that the object OB09 is included in the area AR41 and the object OB10 and the object OB11 are included in the area AR42.

Subsequently, the object display unit 114 calculates the number of objects OB corresponding to each divided area in the objects OB identified in the processing of S102 (S104).

For example, the object display unit 114 figures out “1” as the number of objects OB included in the area AR41 if determining that the object OB09 is included in the area AR41. Furthermore, the object display unit 114 figures out “2” as the number of objects OB included in the area AR42 if determining that the object OB10 and the object OB11 are included in the area AR42, for example.

Thereafter, as illustrated in FIG. 15, the information management unit 115 updates the area information 131 and the object information 132 stored in the information storage area 130 (S111).

For example, as represented at underlined parts in FIG. 28, the information management unit 115 divides the information whose “number” is “4” in the area information 131 illustrated in FIG. 24 into information whose “number” is “4” and information whose “number” is “6.”

For example, as represented at the underlined parts in FIG. 28, as the information whose “number” is “4,” the information management unit 115 sets “AR41” that is the identification information of the area AR41, which is one of the areas defined by dividing the area AR4, in “identification information.” Furthermore, the information management unit 115 sets “1” figured out in the processing of S104 in “the number of objects” and sets “(49, 78), (50, 84), (50, 90) . . . ” that are coordinates of the circumference of the area AR41 in “coordinates (boundary line)” as the information whose “number” is “4” as represented at the underlined parts in FIG. 28, for example.

In addition, for example, as represented at the underlined parts in FIG. 28, as the information whose “number” is “6,” the information management unit 115 sets “AR42” that is the identification information of the area AR42, which is one of the areas defined by dividing the area AR4, in “identification information” and sets “Okinawa” designated in advance by the participant 21 as the label information of the area AR42 in “label information.” Furthermore, the information management unit 115 sets “2” figured out in the processing of S104 in “the number of objects” and sets “(110, 81), (118, 90), (119, 97) . . . ” that are coordinates of the circumference of the area AR42 in “coordinates (boundary line)” as the information whose “number” is “6” as represented at the underlined parts in FIG. 28, for example.

Moreover, for example, as represented at underlined parts in FIG. 29, the information management unit 115 updates the information set in “area” of the pieces of information in which “OB09,” “OB10,” and “OB11” are set in “identification information” in the object information 132 illustrated in FIG. 25 to “AR41,” “AR42,” and “AR42,” respectively.

Thereafter, the information display unit 111 displays, on the display surface 11, information that represents each of the names of the plural divided areas obtained by dividing based on the dividing position about which the designation has been accepted in the processing of S101 and the numbers of objects OB calculated in the processing of S104 (S112).

Then, the object display unit 114 displays the objects OB corresponding to a respective one of the divided areas in the objects OB identified in the processing of S102 in the respective one of the plural divided areas obtained by dividing based on the dividing position about which the designation has been accepted in the processing of S101 (S113).

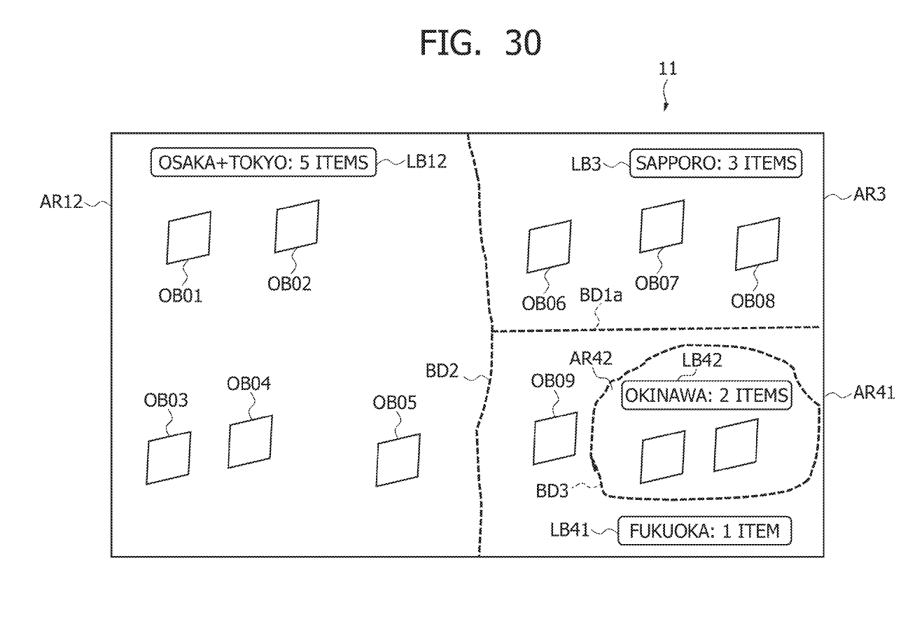

For example, in the information whose “number” is “4” in the area information 131 illustrated in FIG. 28, “Fukuoka” is set as “label information” and “1” is set as “the number of objects.” Thus, as illustrated in FIG. 30, the information display unit 111 displays a label LB41 including information that represents “Fukuoka” and information that represents “1 item” in the range of the area AR41 on the display surface 11 of the desk, for example.

Furthermore, in the information whose “number” is “6” in the area information 131 illustrated in FIG. 28, “Okinawa” is set as “label information” and “2” is set as “the number of objects.” Thus, as illustrated in FIG. 30, the information display unit 111 displays a label LB42 including information that represents “Okinawa” and information that represents “2 items” in the range of the area AR42 on the display surface 11 of the desk, for example.

Moreover, in the object information 132 illustrated in FIG. 29, “OB09” is set as “identification information” of the information in which “AR41” is set in “area.” Thus, as illustrated in FIG. 30, the object display unit 114 displays the object OB09 in the range of the area AR41 on the display surface 11 (the upper surface) of the desk, for example.

Furthermore, in the object information 132 illustrated in FIG. 29, “OB10” and “OB11” are set as “identification information” of the pieces of information in which “AR42” is set in “area.” Thus, as illustrated in FIG. 30, the object display unit 114 displays the object OB10 and the object OB11 in the range of the area AR42 on the display surface 11 (the upper surface) of the desk, for example.

This allows the participant 21 to easily divide an area without causing the participant 21 to directly handle the information that represents the respective areas.

[Details of Object Disposing Processing (2)]

Next, details of another kind of partial processing in the object disposing processing will be described.

As illustrated in FIG. 10, the designation accepting unit 112 waits until accepting designation of intention of disposing the object OB (NO of S61).

For example, the designation accepting unit 112 waits until the participant 21 carries out designation of intention of disposing a new object OB and designation of the display position of the new object OB by using a pen-type input apparatus.

Then, if designation of intention of disposing the object OB is accepted (YES of S61), the information management unit 115 updates the area information 131 and the object information 132 stored in the information storage area 130 according to the contents of the designation accepted in the processing of S61 (S62).

For example, if the display position about which the designation has been accepted in the processing of S61 is included in the area AR12, as represented at an underlined part in FIG. 31, the information management unit 115 updates the information set in “the number of objects” in the information in which “identification information” is “AR12” in the area information 131 illustrated in FIG. 28 to “6.”

Furthermore, for example, if the display position about which the designation has been accepted in the processing of S61 is (82, 150), as represented at underlined parts in FIG. 32, the information management unit 115 adds, to the object information 132 illustrated in FIG. 29, information in which “OB12” is set as “identification information” and “handwritten input” is set as “type” and “(82, 150)” is set as “coordinates” and “AR12” is set as “area” (information whose “number” is “12”).

Subsequently, the area identifying unit 116 refers to the area information 131 stored in the information storage area 130 and determines whether or not one or more areas have been defined (S63).

If determining that one or more areas have been defined as a result (YES of S63), the area identifying unit 116 refers to the area information 131 stored in the information storage area 130 and identifies the area associated with the area in which the object OB about which the designation has been accepted in the processing of S61 is disposed (S65).

For example, the area identifying unit 116 refers to the object information 132 stored in the information storage area 130 and identifies “AR12” that is the information set in “area” of the information in which “identification information” is “OB12.”

Then, the object display unit 114 displays the object OB about which the designation has been accepted in the processing of S61 in the area identified in the processing of S65 (S66).

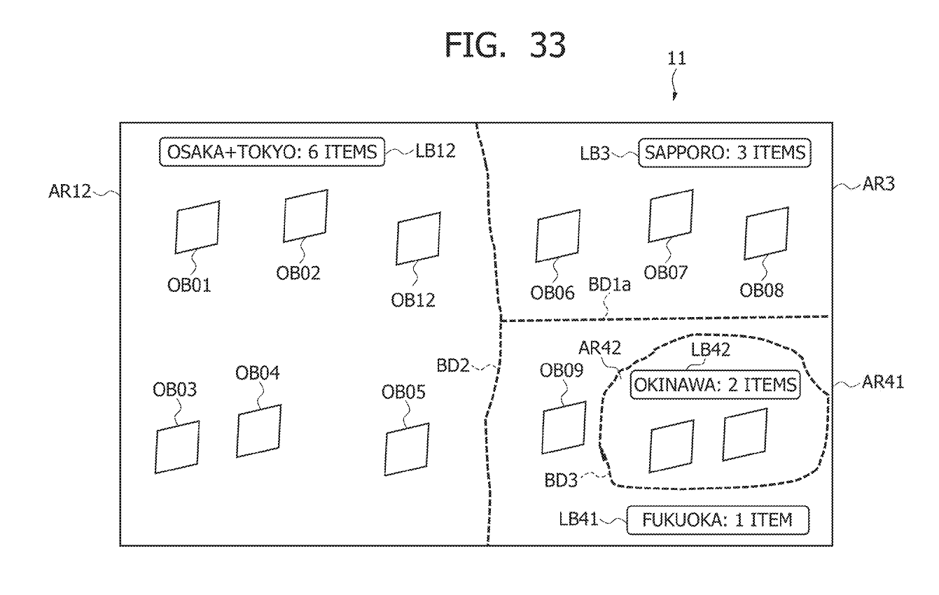

For example, as illustrated in FIG. 33, the object display unit 114 displays the object OB12 at the display position about which the designation has been accepted in the processing of S61 in the region included in the area AR12.

Furthermore, in this case, the information display unit 111 displays a label LB12 including information that represents “Osaka+Tokyo” and information that represents “6 items” in the region included in the area AR12 as illustrated in FIG. 33, for example.

This allows the participant 21 to easily dispose the new object OB in the respective areas without managing the information that represents the respective areas for oneself.

For example, if plural things including a desk and wall) exist in the meeting room 20, the information processing apparatus 1 may be an apparatus that merges an area on the display surface 11 of the desk and an area on the display surface 11 of the wall. In this case, the information management unit 115 updates each of the area information 131 corresponding to the desk (for example, area information 131a illustrated in FIG. 34A) and the area information 131 corresponding to the wall (for example, area information 131b illustrated in FIG. 34B).

For example, if an area AR3 included in the display surface 11 of the desk and an area AR6 included in the display surface 11 of the wall are merged, as represented at underlined parts in FIG. 35A, the information management unit 115 sets “AR36” as “identification information” in the information whose “number” is “3” and sets “Sapporo+Hakodate” as “label information.”

Furthermore, “3” is set as “the number of objects” in the information in which “identification information” is “AR3” in FIG. 34A, and “4” is set as “the number of objects” in the information in which “identification information” is “AR6” in FIG. 34B. Thus, as represented at the underlined part in FIG. 35A, the information management unit 115 sets a fraction whose denominator is “7,” which is the sum of “3” and “4,” and whose numerator is “3” as “the number of objects” in the information whose “number” is “3,” for example.

Moreover, in this case, as represented at underlined parts in FIG. 35B, the information management unit 115 sets “AR36” as “identification information” in the information whose “number” is “2” and sets “Sapporo+Hakodate” as “label information,” for example.

Furthermore, as represented at the underlined part in FIG. 35B, the information management unit 115 sets a fraction whose denominator is “7,” which is the sum of “3” and “4,” and whose numerator is “4” as “the number of objects” in the information whose “number” is “2,” for example.

This allows the participant 21 to easily merge areas without managing the information that represents the respective areas for oneself also in the case of merging the areas each included in a respective one of the different things 11.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A display control method comprising:
displaying, on display surfaces of things, plural pieces of information that respectively represent a plurality of areas on the display surfaces;
upon accepting designation of a first area and a second area among the plurality of areas, with reference to a memory that stores an object displayed in an area in association with the area, identifying a first object displayed in the first area and a second object displayed in the second area; and
displaying, in a third area on the display surfaces, information that represents the third area, together with the identified first object and the identified second object.

2. The display control method of claim 1, further comprising:
storing the identified first object and the identified second object in the memory in association with the third area.

3. The display control method of claim 1, further comprising:
upon accepting the designation, causing each of the first object displayed in the designated first area and the second object displayed in the designated second area to enter a non-displayed state.

4. The display control method of claim 1, further comprising:
upon accepting the designation, suppressing each of display of the first object in the first area and display of the second object in the second area.

5. The display control method of claim 1, wherein
the third area is one of the first area and the second area.

6. The display control method according to claim 1, wherein
the third area is an area different from the first area and the second area.

7. The display control method of claim 1, wherein
the first area and the second area are areas that are not adjacent to each other.

8. The display control method of claim 7, wherein:
the first area is an area included in a first plurality of areas whose information is displayed on a first display surface of a first thing; and
the second area is an area included in a second plurality of areas whose information is displayed on a second display surface of a second thing.

9. A display control method comprising:
displaying, on display surfaces of things, plural pieces of first information that respectively represent a plurality of areas on the display surfaces;
upon accepting designation of dividing positions at which a certain area among the plurality of areas is to be divided into plural sub-areas, with reference to a memory that stores an object displayed in an area and a display position of the object in association with the area, identifying first plural objects displayed in the certain area and display positions of the first plural objects;
based on the identified display positions of the first plural objects and the designated dividing positions, identifying a first sub-area among the plural sub-areas which includes each of the first plural objects; and
displaying, on the display surfaces, plural pieces of second information that respectively represent the plural sub-areas, while displaying, in each of the plural sub-areas, second objects among the first plural objects which correspond to the first sub-area.

10. The display control method of claim 9, further comprising:
storing the second objects, in the memory, in association with the first sub-area including the second objects.

11. The display control method of claim 9, wherein
in the identifying the first sub-area, each of ranges of the plural sub-areas is identified from the dividing positions, and
a sub-area corresponding to a range including the display position of each of the first plural objects is identified, as the first sub-area, from among the plural sub-areas.

12. A display control method comprising:
displaying, on display surfaces of things, plural pieces of information that respectively represent a plurality of areas;
upon detecting an action to dispose an object in a first area among the plurality of areas, with reference to a memory that stores information relating to areas associated with each other, identifying a second area associated with the first area; and
displaying, in the identified second area, the object disposed in the first area.

13. The display control method of claim 12, wherein
the action is an action of moving an object disposed in another area among the plurality of areas, which is different from the first area, to the first area.

14. A display control apparatus comprising:
a memory configured to store an object displayed in an area in association with the area; and
a processor coupled to the memory and configured to:
display, on display surfaces of things, plural pieces of information that respectively represent a plurality of areas,
upon accepting designation of a first area and a second area among the plurality of areas, with reference to the memory, identify a first object displayed in the first area and a second object displayed in the second area, and
display, in a third area on the display surfaces, information that represents the third area, together with the identified first object and the identified second object.

15. A display control apparatus comprising:
a memory configured to store an object displayed in an area and a display position of the object, in association with the area; and
a processor coupled to the memory and configured to:
display, on display surfaces of things, plural pieces of first information that respectively represent a plurality of areas on the display surfaces;
upon accepting designation of dividing positions at which a certain area among the plurality of areas is to be divided into plural sub-areas, with reference to the memory, identify first plural objects displayed in the certain area and display positions of the first plural objects,
based on the identified display positions of the first plural objects and the designated dividing positions, identify a first sub-area among the plural sub-areas which includes each of the first plural objects, and
display, on the display surfaces, plural pieces of second information that respectively represent the plural sub-areas, while displaying, in each of the plural sub-areas, second objects among the first plural objects which correspond to the first sub-area.

16. A display control apparatus comprising:
a memory configured to store information relating to areas associated with each other; and
a processor coupled to the memory and configured to:
display, on display surfaces of things, plural pieces of information that respectively represent a plurality of areas,
upon detecting an action to dispose an object in a first area among the plurality of areas, with reference to the memory, identify a second area associated with the first area, and
display, in the identified second area, the object disposed in the first area.
